(19) United States
(12) Patent Application Publication
(10) Pub. No.: US 2009/0099012 A1
(43) Pub. Date: Apr. 16, 2009

(54) CATALYST-SUPPORTED PARTICULATE

(75) Inventors: Kenji SUZUKI, Higashi-Hiroshima-shi (JP); Koichiro HARADA, Higashi-Hiroshima-shi (JP); Hiroshi YAMADA, Hiroshima-shi (JP); Kenji OKAMOTO, Hiroshima-shi (JP); Akihide TAKAMI, Hiroshima-shi (JP)

Correspondence Address: Studebaker & Brackett PC, 1890 Preston White Drive, Suite 105, Reston, VA, 20191, US

(73) Assignee: MAZDA MOTOR COPORATION, Hiroshima (JP)

(21) Appl. No.: 12/243,439

(22) Filed: Oct. 1, 2008

(30) Foreign Application Priority Data
Oct. 10, 2007 (JP) 2007-264450
Oct. 10, 2007 (JP) 2007-264457
Oct. 10, 2007 (JP) 2007-264475
Oct. 10, 2007 (JP) 2007-264479

(51) Int. Cl. B01J 23/10

(52) U.S. Cl. 502/303; 502/304

(57) ABSTRACT

A catalyst layer formed on the walls of exhaust gas channels in a particulate filter contains a catalyst material in the form of secondary particles, each secondary particle being formed so that at least two kinds of primary particles selected from the group consisting of primary particles of activated alumina, primary particles of a Zr-based mixed oxide and primary particles of a Ce-based mixed oxide are mixed and cohere together. Each of the primary particles of the Zr-based mixed oxide contains Zr and a rare earth metal Z other than Ce and each of the primary particles of the Ce-based mixed oxide contains Ce, Zr and a rare earth metal R other than Ce.

### CROSS-REFERENCES TO RELATED APPLICATIONS

This application claims priority under 35 USC 119 to Japanese Patent Application Nos. 2007-264450, 2007-264457, 2007-264475 and 2007-264479 all filed on Oct. 10, 2007, the entire contents of all of which are incorporated herein by reference.

### BACKGROUND OF THE INVENTION

(a) Field of the Invention

This invention relates to catalyst-supported particulate filters.

(b) Description of the Related Art

Exhaust gases from diesel engines using fuels containing diesel oil as a main component and exhaust gases from gasoline engines using fuels containing gasoline as a main component to burn them under fuel-lean conditions are known to contain not only hydrocarbons (HC), carbon monoxide (CO) and nitrogen oxides (NOx), but also particulates (suspended particulate matters containing carbon particles). To restrain particulates in exhaust gas from being exhausted to the atmosphere, a filter for trapping the particulates is disposed in an exhaust gas passage of such an engine. However, when the amount of particulates deposited on the filter becomes large, this causes deterioration of engine power and specific fuel consumption. Therefore, in this case, it is necessary to burn the deposited particulates as appropriate to remove them from the filter.

To effectively burn such deposited particulates (ignite the particulates at relatively low temperature and burn them out in a short period of time), a catalyst layer containing alumina carrying platinum (Pt) as a catalytic metal is formed on the walls of exhaust gas channels in the body of such a filter. Such Pt-carried alumina is effective in burning particulates as well as converting HC and CO, but there have been recently developed catalyst materials for filters capable of more efficiently burning particulates.

Published Japanese Patent Application No. 2006-326573 describes the use of such a catalyst material in a filter. The catalyst material is a material in which a catalytic metal, such as Pt, is carried on a mixed oxide (composite oxide) containing cerium (Ce), zirconium (Zr) and a rare earth metal R selected from among praseodymium (Pr), neodymium (Nd) and lanthanum (La). The published document also describes that the content of R in the mixed oxide is preferably 2% to 11% by mole, both inclusive. Since such a mixed oxide contains Ce, it has oxygen storage/release capacity so that oxygen released from the mixed oxide promotes ignition and burning of particulates.

Published Japanese Patent Application No. 2007-54713 describes the use of another catalyst material in a filter. The catalyst material is a material in which a catalytic metal is carried on mixed oxide ZrRO particles containing Zr and a rare earth metal R selected from among ytterbium (Yb), Nd and scandium (Sc) and having an R content of up to 18% by mole and mixed oxide CeMO particles containing Ce and a rare earth metal M selected from among samarium (Sm) and gadolinium (Gd). The ZrRO particles have oxygen ion conductivity to thereby release active oxygen but their oxygen release mechanism is different from that of CeZr-based mixed oxides as disclosed in Published Japanese Patent Application No. 2006-326573.

Specifically, CeZr-based mixed oxides have high oxygen storage capacity and release active oxygen by the valence change of Ce ions. On the other hand, the ZrRO particles have oxygen ion conductivity, i.e., so-called oxygen pumping function, and, when having both of high-oxygen concentration sites and low-oxygen concentration sites on the particle surfaces, transport oxygen ions from high-oxygen concentration sites to low-oxygen concentration sites and then release them as active oxygen.

Therefore, for the ZrRO particles, when a small ignition site causing particulates to burn is formed on their surface and then falls into lack of oxygen, oxygen is transported from other high-oxygen concentration sites. Thus, the burning is continued and the burning region on each particle can be easily extended from the ignition site to the surrounding sites.

Published Japanese Patent Application No. 2007-83224 describes the use of still another catalyst material in a filter. The catalyst material is a material in which a catalytic precious metal is carried on ZrRO having oxygen ion conductivity as stated above and alumina.

Published Japanese Patent Application No. 2007-98200 describes a method for manufacturing a catalyst material for converting exhaust gas components. In this method, an excessive amount of aqueous ammonia is first added to a mixture of an aqueous solution of aluminium nitrate and an aqueous solution of lanthanum nitrate to precipitate a fist hydroxide containing Al and La. Next, a mixture of an aqueous solution of cerium nitrate and an aqueous solution of zirconium nitrate is further added to the above mixture to precipitate a second hydroxide containing Ce and Zr over the precipitate of the first hydroxide. Then, the obtained precipitate of the first and second hydroxides is filtrated, dried and calcined. According to this method, a catalyst material is obtained in which each of activated alumina particles containing La forms a core and the whole surface of the core is covered with a CeZr-mixed oxide serving as a shell.

### SUMMARY OF THE INVENTION

The above CeZr-based mixed oxide particles having oxygen storage capacity and the above Zr-based mixed oxide particles having oxygen ion conductivity promote the conversion of HC and CO by oxidation and also promote the ignition and burning of particulates deposited on the filter. These mixed oxide particles, however, have the following problems.

These mixed oxide particles can be obtained by a coprecipitation method in which a basic solution is added to and mixed with an acid solution containing metal ions, such as Ce or Zr, to obtain a precipitate and the precipitate is dried and calcined. In this case, primary particles of a mixed oxide are formed by calcining the precipitate and secondary particles are formed by cohesion and growth of the primary particles. If such mixed oxide secondary particles are exposed to high-temperature exhaust gas, they further cohere and grow to reduce their surface areas. Thus, exhaust gas is prevented from smoothly diffusing into the insides of the particles and in turn catalytic metal particles are buried in the particles or cohere, which deteriorates the HC and CO conversion performance and the particulate burning property.

Furthermore, for CeZr-based mixed oxide particles having oxygen storage capacity, oxygen storage and release occur mainly at their surfaces and their insides are hardly involved in oxygen storage and release. Therefore, if the particle size increases, each particle increases the internal volume not used for oxygen storage and release and accordingly deteriorates the oxygen storage/release efficiency.

For Zr-based mixed oxide particles having oxygen ion conductivity, if the particle size increases, each particle increases the distance for which an oxygen ion is conducted from a high-oxygen concentration site on the surface through the inside to a low-oxygen concentration on the surface and the oxygen concentration gradient in the inside of the particle decreases. As a result, its oxygen ion conductivity deteriorates and the amount of oxygen supplied from the inside of the particle is reduced.

For the catalyst material disclosed in Published Japanese Patent Application No. 2007-98200, the Ce—Zr mixed oxide particles serving as a shell have relatively small particle size and the activated alumina particle serving as a core also has a small particle size (approximately 0.05 μm at maximum). The reason for this is as follows. The precursor of the activated alumina primary particle is a precipitated particle of a hydroxide containing Al and La. A hydroxide containing Ce and Zr (a Ce—Zr mixed oxide precursor) precipitates over the precipitated particle serving as the precursor of the primary particle to cover the precipitated particle. As a result, the Ce—Zr mixed oxide prevents cohesion of activated alumina particles, whereby the activated alumina particles have small particle size.

Thus, the whole surface of each activated alumina particle is covered with Ce—Zr mixed oxide particles. Therefore, the catalytic metal is carried on the Ce—Zr mixed oxide particles but hardly carried on the activated alumina particles serving as cores. As a result, the activated alumina particles are not effectively used as a support material allowing the catalytic metal to be carried on the catalyst with high dispersivity, whereby the catalyst cannot be expected to provide a high catalytic activity. Furthermore, the catalyst particles (particles in each of which the surface of an activated alumina particle is covered with Ce—Zr mixed oxide particles) are in contact at their Ce—Zr mixed oxide particles of the same composition with each other. Therefore, when exposed to high-temperature exhaust gas, the catalyst particles are likely to cohere and grow, which may deteriorate the catalytic activity.

With the foregoing in mind, an object of the invention is to provide a catalyst-supported particulate filter enhancing the conversion performance for exhaust gas components (including HC, CO and particulates) and enhancing the heat resistance of the catalyst material.

Specifically, an aspect of the invention is a particulate filter in which a catalyst layer is formed on the walls of exhaust gas channels in a filter body for trapping particulates exhausted from an engine, the catalyst layer containing a catalyst material in the form of secondary particles, each secondary particle being formed so that at least two kinds of primary particles selected from the group consisting of primary particles of activated alumina, primary particles of a Zr-based mixed oxide containing Zr and a rare earth metal Z other than Ce and primary particles of a Ce-based mixed oxide (CeZr-based mixed oxide, hereinafter referred to it as Ce-based mixed oxide) containing Ce, Zr and a rare earth metal R other than Ce are mixed and cohere together.

According to this aspect of the invention, primary particles of the Zr-based mixed oxide and/or primary particles of the Ce-based mixed oxide are mixed with the other kind or kinds of primary particles to form a secondary particle. Therefore, even when the particulate filter is exposed to high-temperature exhaust gas or reaches a high temperature, primary particles of the Zr-based mixed oxide and/or primary particles of the Ce-based mixed oxide are prevented from cohering together and thereby growing by the other kind or kinds of primary particles, which avoids deterioration of the catalyst material.

In each secondary particle, the Zr-based mixed oxide is dispersed in the form of small particles. Thus, in each of the Zr-based mixed oxide particles constituting part of the secondary particle, the amount of oxygen ions supplied from high-oxygen concentration sites on the particle surface to low-oxygen concentration sites thereon increases, which is advantageous in promoting the oxidation of HC and CO and the burning of particulates.

On the other hand, also for the Ce-based mixed oxide, each of its primary particles constituting part of the secondary particle has a small particle size. Therefore, the primary particles have large specific surface area and thereby have high oxygen storage/release efficiency. It is believed that when Ce-based mixed oxide particles are used in a three-way catalyst repeating oxygen-rich conditions (fuel-lean conditions) and oxygen-lean conditions (fuel-rich conditions), they store oxygen under fuel-lean conditions and release oxygen under fuel-rich conditions. However, Ce-based mixed oxide particles perform “oxygen exchange reactions” in which even under fuel-lean conditions they release active oxygen from inside the particle while taking oxygen into inside the particle (see Published Japanese Patent Application No. 2007-190460 filed in Japan by the Assignee). Therefore, the Ce-based mixed oxide particles release active oxygen by the valence change of Ce ions even in an oxygen-rich gas atmosphere. This is advantageous in promoting the oxidation of HC and CO and the burning of particulates.

In addition, since the catalyst material is formed in the form of secondary particles by the mixture of two or more kinds of primary particles, the carrying of a catalytic metal on the catalyst material composed of secondary particles is equivalent to the carrying of the catalytic metal on various kinds of primary particles exposed on the surface of each secondary particle, which is advantageous in promoting the oxidation of HC and CO and the burning of particulates.

The catalyst material may comprise secondary particles in each of which primary particles of the activated alumina and primary particles of the Zr-based mixed oxide cohere together. In this case, each of the primary particles of the Zr-based mixed oxide preferably contains, as the rare earth metal Z, Nd and a rare earth metal M other than Ce and Nd. This gives advantage in promoting the oxidation of HC and CO and the burning of particulates.

In the above case, when the particulate filter is exposed to high-temperature exhaust gas or reaches a high temperature, the mixed oxide particles prevent the activated alumina particles from cohering together and growing. In addition, the activated alumina particles prevent the Zr-based mixed oxide particles from cohering together and growing.

When a catalytic metal is carried on the catalyst material, the catalytic metal is carried not only on the Zr-based mixed oxide particles but also on the activated alumina particles. Therefore, the activated alumina particles having large specific surface area effectively act as a support material for carrying the catalytic metal with high dispersivity, whereby oxidation of HC and CO in exhaust gas and oxidation of NO in exhaust gas into NO₂ can be accomplished using the catalytic metal carried on the activated alumina particles. Furthermore, heat produced by oxidation reaction of these exhaust gas components promotes the burning of the particulates and produced NO₂ serves as an oxidizing agent for efficiently burning the particulates. Furthermore, the catalytic metal effectively acts to promote the conduction of oxygen ions in the Zr-based mixed oxide particles and active oxygen released from the Zr-based mixed oxide particles is efficiently used when the catalytic metal promotes the oxidation of HC and CO and the burning of particulates.

Each of the primary particles of the Zr-based mixed oxide preferably contains ZrO₂ at a proportion of 55% to 78% by mole, both inclusive. This provides high particulate burning property while enhancing HC and CO conversion performance at low temperatures.

The proportion of the primary particles of the Zr-based mixed oxide in the total amount of the primary particles of the activated alumina and the primary particles of the Zr-based mixed oxide is preferably 25% to 90% by mass, both inclusive. This provides high particulate burning property while enhancing HC and CO conversion performance at low temperatures. More preferably, the proportion of the mixed oxide primary particles is 25% to 50% by mass, both inclusive.

Examples of the rare earth metal M contained in the Zr-based mixed oxide particle include La, Pr, Sm, Gd and Y (yttrium). What is preferable in enhancing the particulate burning property is the use of at least one selected from the group consisting of La and Pr.

Furthermore, Pt is preferably used as the catalytic metal. When Pt is carried on the activated alumina particles, this is advantageous in oxidation of NO in exhaust gas into NO₂. Thus, particulates can be efficiently burned using NO₂ as an oxidizing agent.

The catalyst material may comprise secondary particles in each of which primary particles of the activated alumina and primary particles of the Ce-based mixed oxide cohere together. Also in this case, when the particulate filter is exposed to high-temperature exhaust gas or reaches a high temperature, the Ce-based mixed oxide particles prevent the activated alumina particles from cohering together and growing. In addition, the activated alumina particles prevent the Ce-based mixed oxide particles from cohering together and growing. Furthermore, when a catalytic metal is carried on the catalyst material, the catalytic metal is carried on the activated alumina particles and the Ce-based mixed oxide particles, which provides the same effects as in the case of the combination of the activated alumina particles and the Zr-based mixed oxide particles.

Each of the primary particles of the Ce-based mixed oxide preferably contains CeO₂ at a proportion of 20% to 60% by mole, both inclusive. This provides high particulate burning property while ensuring HC and CO conversion performance at low temperatures. More preferably, the proportion of CeO₂ is 20% to 45% by mole, both inclusive. This gives advantage in enhancing HC and CO conversion performance at low temperatures.

Examples of the rare earth metal R contained in the Ce-based mixed oxide particle include La, Nd, Pr, Sm, Gd and Y. What is preferable in enhancing the particulate burning property is the use of at least one selected from the group consisting of Nd, La, Pr and Y.

The proportion of the primary particles of the Ce-based mixed oxide in the total amount of the primary particles of the activated alumina and the primary particles of the Ce-based mixed oxide is preferably 10% to 75% by mass, both inclusive. This provides high particulate burning property while ensuring HC and CO conversion performance at low temperatures. More preferably, the proportion of the mixed oxide primary particles is 25% to 50% by mass, both inclusive.

Furthermore, Pt is preferably used as the catalytic metal. When Pt is carried on the activated alumina particles, this is advantageous in oxidation of NO in exhaust gas into NO₂ Thus, particulates can be efficiently burned using NO₂ as an oxidizing agent.

The catalyst material may comprise secondary particles in each of which primary particles of the Zr-based mixed oxide and primary particles of the Ce-based mixed oxide cohere together. In this case, each of the primary particles of the Zr-based mixed oxide preferably contains, as the rare earth metal Z, Nd and a rare earth metal M other than Ce and Nd. This gives advantage in promoting the oxidation of HC and CO and the burning of particulates.

Also in the case where primary particles of the Zr-based mixed oxide and primary particles of the Ce-based mixed oxide are mixed to form a secondary particle, when the particulate filter is exposed to high-temperature exhaust gas or reaches a high temperature, the Ce-based mixed oxide particles prevent the Zr-based mixed oxide particles from cohering together and growing. In addition, the Zr-based mixed oxide particles prevent the Ce-based mixed oxide particles from cohering together and growing.

Furthermore, since the particles of both the mixed oxides are mixed to expose on the surface of each secondary particle, the carrying of a catalytic metal on such a catalyst material is equivalent to the carrying of the catalytic metal on each of the particles of both the mixed oxides. Therefore, the catalytic metal effectively acts to promote the oxygen storage and release in the Ce-based mixed oxide particles and the conduction of oxygen ions in the Zr-based mixed oxide particles, and active oxygen released from the particles of both the mixed oxides is efficiently used when the catalytic metal promotes the oxidation of HC and CO and the burning of particulates.

Each of the primary particles of the Zr-based mixed oxide preferably contains ZrO₂ at a proportion of 55% to 75% by mole, both inclusive, and each of the primary particles of the Ce-based mixed oxide preferably contains CeO₂ at a proportion of 20% to 45% by mole, both inclusive. This provides high particulate burning property while enhancing HC and CO conversion performance at low temperatures.

The proportion of the primary particles of the Ce-based mixed oxide in the total amount of the primary particles of the Zr-based mixed oxide and the primary particles of the Ce-based mixed oxide is preferably 25% to 75% by mass, both inclusive. This provides high particulate burning property while ensuring HC and CO conversion performance at low temperatures. The proportion of the Ce-based mixed oxide primary particles is more preferably 25% to 65% by mass, both inclusive, and still more preferably 25% to 50% by mass, both inclusive.

Examples of the rare earth metal M contained in the Zr-based mixed oxide particle include La, Pr, Sm, Gd and Y. What is preferable in enhancing the particulate burning property is the use of at least one selected from the group consisting of La and Pr.

Examples of the rare earth metal R contained in the Ce-based mixed oxide particle include La, Nd, Pr, Sm, Gd and Y. What is preferable in enhancing the particulate burning property is the use of at least one selected from the group consisting of Nd, La, Pr and Y.

Furthermore, Pt is preferably used as a catalytic metal that is to be carried on the catalyst material comprising secondary particles, each constituted by a mixture of primary particles of both the mixed oxides. Furthermore, the catalyst layer preferably contains activated alumina particles on which Pt is carried. Pt carried on the activated alumina particles promotes the oxidation of NO in exhaust gas into NO₂. Thus, particulates can be efficiently burned using NO₂ as an oxidizing agent.

The catalyst material may comprise secondary particles in each of which primary particles of the activated alumina, primary particles of the Zr-based mixed oxide and primary particles of the Ce-based mixed oxide cohere together. In this case, when the particulate filter is exposed to high-temperature exhaust gas or reaches a high temperature, the Zr-based mixed oxide particles and the Ce-based mixed oxide particles prevent the activated alumina particles from cohering together and growing. In addition, cohesion and particle growth of one of the Zr-based mixed oxide particles and the Ce-based mixed oxide particles can be prevented by the other mixed oxide particles and the activated alumina particles.

Furthermore, since in the catalyst material the particles of the activated alumina and both the mixed oxides are mixed to expose on the surface of each secondary particle, the carrying of a catalytic metal on the catalyst material is equivalent to the carrying of the catalytic metal on each of the particles of the activated alumina and both the mixed oxides.

Therefore, the activated alumina particles having large specific surface area effectively act as a support material for carrying the catalytic metal (such as Pt) with high dispersivity, whereby oxidation of HC and CO in exhaust gas and oxidation of NO in exhaust gas into NO₂ can be accomplished using the catalytic metal carried on the activated alumina particles. Furthermore, heat produced by oxidation reaction of these exhaust gas components promotes the burning of the particulates and produced NO₂ serves as an oxidizing agent for efficiently burning the particulates.

Furthermore, the catalytic metal effectively acts to promote the conduction of oxygen ions in the Zr-based mixed oxide particles and the oxygen storage and release in the Ce-based mixed oxide particles, and active oxygen released from the particles of both the mixed oxides is efficiently used when the catalytic metal promotes the oxidation of HC and CO and the burning of particulates.

The mass ratio among the primary particles of the activated alumina, the primary particles of the Zr-based mixed oxide and the primary particles of the Ce-based mixed oxide is preferably within the range enclosed by the lines connecting Point A (15:10:75), Point B (15:75:10) and Point C (75:15:10) in a triangular chart formed by the primary particles of the activated alumina, the primary particles of the Zr-based mixed oxide and the primary particles of the Ce-based mixed oxide. This provides high particulate burning property while enhancing HC and CO conversion performance at low temperatures.

Each of the primary particles of the Zr-based mixed oxide preferably contains ZrO₂ at a proportion of 55% to 75% by mole, both inclusive. This provides high particulate burning property while enhancing HC and CO conversion performance at low temperatures.

Examples of the rare earth metal Z contained in the Zr-based mixed oxide particle include Nd, La, Pr, Sm, Gd and Y. What is preferable in enhancing the particulate burning property is the use of Nd and at least one selected from the group consisting of La and Pr.

Examples of the rare earth metal R contained in the Ce-based mixed oxide particle include La, Nd, Pr, Sm, Gd and Y. Particularly, each of the Ce-based mixed oxide particles preferably contains at least one selected from the group consisting of Nd, La and Pr. Each of the primary particles of the Ce-based mixed oxide preferably contains CeO₂ at a proportion of 20% to 45% by mole, both inclusive. This provides high particulate burning property while enhancing HC and CO conversion performance at low temperatures.

Furthermore, Pt is preferably used as a catalytic metal that is to be carried on the catalyst material. Thus, Pt can be carried on the activated alumina particles. Therefore, the oxidation of NO in exhaust gas into NO₂ can be promoted and particulates can be efficiently burned using NO₂ as an oxidizing agent.

### BRIEF DESCRIPTION OF THE DRAWINGS

FIG. 1 is a schematic view showing the state that a particulate filter is disposed in an exhaust gas passage of an engine.

FIG. 2 is a front view schematically showing the particulate filter.

FIG. 3 is a longitudinal cross-sectional view schematically showing the particulate filter.

FIG. 4 is an enlarged cross-sectional view schematically showing a wall that separates an exhaust gas inflow channel from an exhaust gas outflow channel in the particulate filter.

FIG. 5 is a schematic view showing a catalyst particle according to Embodiment 1.

FIG. 6 is a graph showing the relation between carbon burning rate and the proportion of each of two kinds of rare earth metal M oxides in their respective Zr-based mixed oxides.

FIG. 7 is a graph showing the relation between carbon burning rate and the ZrO₂ ratio of each of inventive examples according to Embodiment 1 and comparative examples.

FIG. 8 is a graph showing the relation between carbon burning rate and the ZrNdMO ratio of each of inventive examples according to Embodiment 1 and comparative examples.

FIG. 9 is a graph showing the relation between light-off temperature and the ZrO₂ ratio of each of inventive examples according to Embodiment 1 and comparative examples.

FIG. 10 is a graph showing the relation between light-off temperature and the ZrNdMO ratio of each of inventive examples according to Embodiment 1 and comparative examples.

FIG. 11 is a schematic view showing a catalyst particle according to Embodiment 2.

FIG. 12 is a graph showing the relation between carbon burning rate and the proportion of each of various kinds of rare earth metal R oxides in their respective Ce-based mixed oxides.

FIG. 13 is a graph showing the relation between carbon burning rate and the CeO₂ ratio of each of inventive examples according to Embodiment 2 and comparative examples.

FIG. 14 is a graph showing the relation between carbon burning rate and the CeZrRO ratio of each of inventive examples according to Embodiment 2 and comparative examples.

FIG. 15 is a graph showing the relation between light-off temperature and the CeO₂ ratio of each of inventive examples according to Embodiment 2 and comparative examples.

FIG. 16 is a graph showing the relation between light-off temperature and the CeZrRO ratio of each of inventive examples according to Embodiment 2 and comparative examples.

FIG. 17 is a schematic view showing a catalyst particle according to Embodiment 3.

FIG. 18 is a graph showing the relation between carbon burning rate and the CeZrRO ratio of each of inventive examples according to Embodiment 3 and comparative examples.

FIG. 19 is a graph showing the relation between light-off temperature and the CeZrRO ratio of each of the inventive examples according to Embodiment 3 and the comparative examples.

FIG. 20 is a schematic view showing a catalyst particle according to Embodiment 4.

FIG. 21 is a triangular chart showing the mass ratio among activated alumina (Al₂O₃), Zr-based mixed oxide (ZrNdMO) and Ce-based mixed oxide (CeZrRO).

FIG. 22 is a graph showing the relation between carbon burning rate and the mixing ratio among activated alumina, Zr-based mixed oxide and Ce-based mixed oxide in each of inventive examples according to Embodiment 4 and comparative examples.

FIG. 23 is a graph showing the relation between light-off temperature for HC conversion and the mixing ratio among activated alumina, Zr-based mixed oxide and Ce-based mixed oxide in each of the inventive examples according to Embodiment 4 and the comparative examples.

FIG. 24 is a graph showing the relation between light-off temperature for CO conversion and the mixing ratio among activated alumina, Zr-based mixed oxide and Ce-based mixed oxide in each of the inventive examples according to Embodiment 4 and the comparative examples.

### DETAILED DESCRIPTION OF THE INVENTION

Hereinafter, embodiments of the present invention will be described with reference to the drawings. Note that the following description of the preferred embodiments is merely illustrative in nature and is not intended to limit the scope, applications and use of the invention.

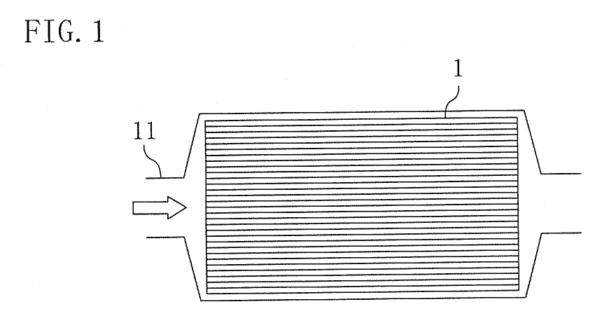

In FIG. 1, reference numeral 1 denotes a particulate filter (hereinafter, referred to simply as a “filter”) disposed in an exhaust gas passage 11 of an engine. An oxidation catalyst (not shown) can be disposed in the exhaust gas passage 11 upstream of the filter 1 in the flow direction of exhaust gas. Such an oxidation catalyst is obtained by carrying a catalytic metal, such as platinum (Pt) or palladium (Pd), on a support material such as activated alumina. When such an oxidation catalyst is disposed upstream of the filter 1, HC and CO in the exhaust gas are oxidized by the oxidation catalyst and heat of the oxidation combustion increases the temperature of exhaust gas flowing into the filter 1. Furthermore, NO in the exhaust gas is oxidized into NO₂ by the oxidation catalyst and produced NO₂ is then supplied as an oxidizing agent for burning particulates to the filter 1.

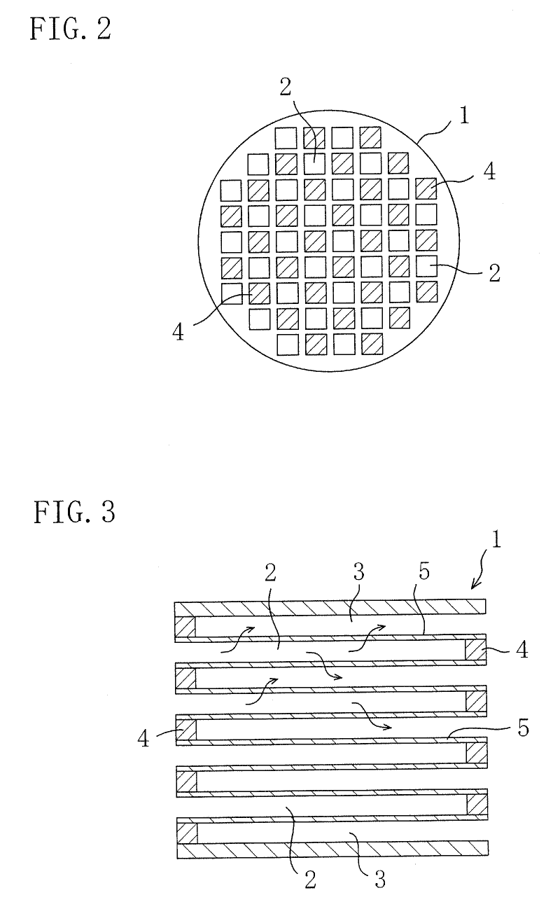

As schematically shown in FIGS. 2 and 3, the filter 1 has a honeycomb structure in which a large number of exhaust gas channels 2 and 3 run in parallel with each other. Specifically, the filter 1 has a structure in which a plurality of exhaust gas inflow channels 2 and a plurality of exhaust gas outflow channels 3 are alternately arranged vertically and horizontally. Each exhaust gas inflow channel 2 is closed at the downstream end by a plug 4, while each exhaust gas outflow channel 3 is closed at the upstream end by a plug 4. The adjacent exhaust gas inflow and outflow channels 2 and 3 are separated from each other by a thin partition wall 5. In FIG. 2, the hatched parts denote the plugs 4 at the upstream ends of the exhaust gas outflow channels 3.

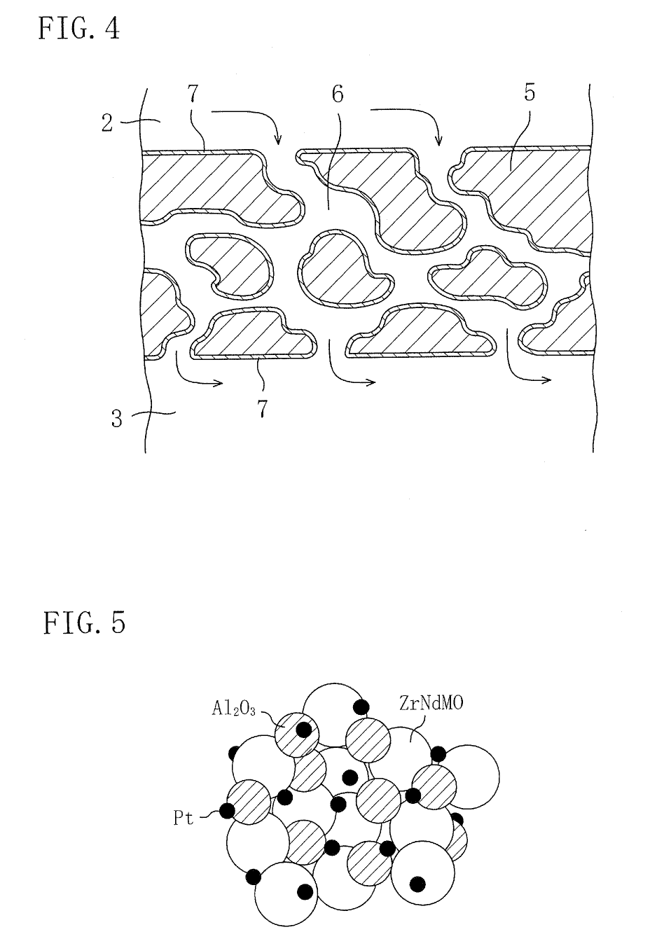

The body of the filter 1, inclusive of the partition walls 5, is formed of cordierite or an inorganic porous material, such as SiC, Si₃N₄ or sialon. The exhaust gas flowing into each exhaust gas inflow channel 2 flows out through the surrounding partition walls 5 into the adjacent exhaust gas outflow channels 3, as shown in the arrows in FIG. 3. More specifically, as shown in FIG. 4, each partition wall 5 has micro pores (exhaust gas channels) 6 communicating the exhaust gas inflow channel 2 with the adjacent exhaust gas outflow channel 3 so that the exhaust gas flows through the micro pores 6. Particulates are trapped and deposited mainly on the wall surfaces of the exhaust gas inflow channels 2 and the micro pores 6.

A catalyst layer 7 is coated on the walls of all the exhaust gas channels (i.e., exhaust gas inflow channels 2, exhaust gas outflow channels 3 and micro pores 6) in the body of the filter 1. However, it is not necessarily required to form the catalyst layer on the walls of the exhaust gas outflow channels 3.

A description is given below of Embodiments 1 to 4 having different catalyst materials used for their respective catalyst layers 7.

### Embodiment 1

A feature of this embodiment is that the catalyst layer 7 contains catalyst particles (a catalyst material) as schematically shown in FIG. 5. Specifically, the catalyst particle is a secondary particle formed so that primary particles of activated alumina (hatched particles; Al₂O₃) and primary particles of a Zr-based mixed oxide that contains Zr and a rare earth metal Z containing no Ce and composed of Nd and a rare earth metal M other than Ce and Nd (particles indicated by unfilled circles; ZrNdMO) are mixed and cohere together. Pt particles (indicated by filled circles) are carried as a catalytic metal on each primary particle of activated alumina (Al₂O₃) and each primary particle of the Zr-based mixed oxide (ZrNdMO). The primary particles of activated alumina have a mean particle size of 1 to 100 nm and the primary particles of the Zr-based mixed oxide have a mean particle size of 5 to 50 nm.

### <Preparation of Catalyst Material>

The catalyst material can be prepared according to the following method.

### —Preparation of Activated Alumina Particle Precursor—

First, an acid solution containing Al ions and La ions is prepared. Aluminium nitrate enneahydrate and lanthanum nitrate hexahydrate can be used as source materials for Al and La, respectively. Respective given amounts of the Al source material and the La source material are mixed with water to prepare a source solution having acidity.

A basic solution is added to the source solution and mixed to produce precipitated particles of an Al-La mixed hydroxide that is a precursor of activated alumina primary particles. In this case, for example, the source solution is stirred at room temperature for about one hour and aqueous ammonia with a concentration of about 7%, for example, is then mixed as a basic solution to the source solution. Instead of the aqueous ammonia, another basic solution, such as an aqueous solution of caustic soda, may be used.

### —Preparation of Zr-Based Mixed Oxide Particle Precursor—

First, an acid solution containing Zr ions, Nd ions and ions of a rare earth metal M other than Ce and Nd is prepared. Zirconium oxynitrate dihydrate and neodymium nitrate can be used as source materials for Zr and Nd, respectively. A nitrate salt of La, Pr or Y can be used as a source material for the rare earth metal M. Respective given amounts of the Zr source material, the Nd source material and the M source material are mixed with water to prepare a source solution having acidity.

A basic solution is added to the source solution and mixed to produce precipitated particles of a Zr—Nd-M mixed hydroxide that is a precursor of Zr-based mixed oxide primary particles. In this case, for example, the source solution is stirred at room temperature for about one hour and aqueous ammonia with a concentration of about 7%, for example, is then mixed as the basic solution to the source solution. Instead of the aqueous ammonia, another basic solution, such as an aqueous solution of caustic soda, may be used.

### —Mixing of Activated Alumina Particle Precursor and Zr-Based Mixed Oxide Particle Precursor—

The activated alumina particle precursor and the Zr-based mixed oxide particle precursor, which are obtained in the above steps, are mixed. Specifically, a solution containing a precipitate of the activated alumina particle precursor is mixed with a solution containing a precipitate of the Zr-based mixed oxide particle precursor. In this case, the two solutions are previously formulated to have the same pH.

### —Rinsing and Dehydration—

The mixed solution containing a precipitate of the activated alumina particle precursor and the Zr-based mixed oxide particle precursor is subjected to centrifugation to remove the supernatant liquid. Ion-exchanged water is further added to the dehydrated precipitate obtained by the removal of the supernatant liquid, stirred and subjected to centrifugation (dehydrated) again. This cycle of rinsing and dehydration is repeated several times. By repeating the cycle of rinsing and dehydration, the remaining basic solution is removed.

### —Drying and Calcining—

The dehydrated precipitate is dried, then calcined and ground. The drying can be implemented, for example, by keeping the dehydrated precipitate at a temperature of about 100° C. to about 250° C. for a predetermined time in the atmospheric environment. The calcining can be implemented, for example, by keeping the dehydrated precipitate at a temperature of about 400° C. to about 600° C. for several hours in the atmospheric environment. Thus, a support material is obtained in the form of a powder of secondary particles in each of which primary particles of activated alumina containing La and primary particles of the Zr-based mixed oxide containing Zr, Nd and the rare earth metal M are mixed and cohere together.

### —Carrying of Catalytic Metal on Support Material—

The obtained powdered support material is mixed with a catalytic metal solution containing catalytic metal ions and then evaporated to dryness to obtain a dried residue. The residue is ground. Thus, a catalyst material composed of catalyst particles as shown in FIG. 5 is obtained. Examples of the catalytic metal solution used include a precious metal solution, such as a solution of diamminedinitro platinum nitrate or an aqueous solution of palladium nitrate. To obtain a catalyst material, the powdered support material may be impregnated with the catalytic metal solution, dried and calcined.

### <Preferred Zr-Based Mixed Oxide Particle>

A description is given below of a preferred composition of the Zr-based mixed oxide particle with reference to the following carbon burning property test in which carbon particulates were used as particulates.

### —Preparation of Samples—

To determine a preferred composition of the Zr-based mixed oxide, various kinds of Zr-based mixed oxide powders using La, Pr and Y as the rare earth metal M and having different proportions of Nd₂O₃ and different proportions of rare earth metal M oxide were prepared. First, Pt-carried catalyst materials were prepared by mixing each kind of Zr-based mixed oxide powder with a solution of diamminedinitro platinum nitrate and ion-exchanged water, evaporating the mixture to dryness, then well drying it and calcining it at 500° C. for two hours in the atmospheric environment. Note that the catalyst materials contained no activated alumina.

Then, samples (catalyst-supported particulate filters) were obtained by mixing each of the obtained catalyst materials with a binder and ion-exchanged water into a slurry, coating the slurry on a support for a filter made of silicon carbide (SiC) having a volume of 25 mL, a cell wall thickness of 16 mil (406.4×10⁻³ mm) and 178 cpsi (i.e., the number of cells per square inch (645.16 mm²)), then drying it and calcining it by keeping it at 500° C. for two hours in the atmospheric environment. The amount of each Zr-based mixed oxide powder carried per L of filter was 50 g/L, and the amount of Pt carried per L of filter was 0.5 g/L. Then, each sample was heat aged by keeping it at 800° C. for 24 hours in the atmospheric environment.

Next, 10 mL ion-exchanged water was added to an amount of carbon (carbon black) corresponding to 10 g per L of filter and stirred for five minutes with a stirrer, thereby well dispersing carbon into the water. One end surface of each sample was dipped into the carbon-dispersed water and, concurrently, water in the sample was aspirated from the other end surface with an aspirator. Water having not been removed by the aspiration was removed by air blow from the one end surface and the sample was then put in a dry oven and dried therein by keeping it at 150° C. for two hours. Thus, carbon was deposited on the walls of exhaust gas channels in the sample filter.

### —Carbon Burning Property Test—

The sample was attached to a fixed-bed, simulated gas flow reactor. In this state, simulated exhaust gas (composed of 10% O₂, 300ppm NO, 10% H₂O and N₂) was allowed to flow through the sample at a space velocity of 80000/h and, concurrently, the gas temperature at the catalyst sample entrance was increased at a rate of 15° C./min. Then, the amount of CO produced and the carbon burning rate at the time when the gas temperature reaches 590° C. were measured. The carbon burning rate was calculated based on the amounts of CO and CO₂ produced by carbon burning and according to the following equation. The measurement results are shown in Table 1.

Carbon burning rate (g/hr)={gas flow rate (L/hr)×[(CO+CO₂) concentration (ppm)/(1×10⁶)]}×12 (g/mol)/22.4 (L/mol)

TABLE 1

| | | | | | Carbon burning | Produced |
|---|---|---|---|---|---|---|
| Sample | Nd oxide | M oxide | | Total amount | rate at 590° C. | CO |
| Number | (% by mole) | (% by mole) | Type of M | (% by mole) | (g/hr) | (ppm) |
| 1 | 12.0 | 0.0 | — | 12.0 | 0.70 | — |
| 2 | 20.0 | 0.0 | — | 20.0 | 0.71 | — |
| 3 | 0.0 | 12.0 | La | 12.0 | 0.68 | — |
| 4 | 0.0 | 12.0 | Pr | 12.0 | 0.69 | — |
| 5 | 6.0 | 6.0 | La | 12.0 | 0.72 | — |
| 6 | 6.0 | 12.0 | La | 18.0 | 0.72 | — |
| 7 | 12.0 | 3.0 | La | 15.0 | 0.74 | — |
| 8 | 12.0 | 6.0 | La | 18.0 | 0.79 | — |
| 9 | 12.0 | 12.0 | La | 24.0 | 0.75 | — |
| 10 | 18.0 | 6.0 | La | 24.0 | 0.78 | — |
| 11 | 18.0 | 12.0 | La | 30.0 | 0.77 | — |
| 12 | 6.0 | 6.0 | Pr | 12.0 | 0.71 | — |
| 13 | 6.0 | 12.0 | Pr | 18.0 | 0.77 | — |
| 14 | 12.0 | 3.0 | Pr | 15.0 | 0.72 | — |
| 15 | 12.0 | 6.0 | Pr | 18.0 | 0.74 | — |
| 16 | 12.0 | 12.0 | Pr | 24.0 | 0.82 | 4 |
| 17 | 12.0 | 18.0 | Pr | 30.0 | 0.87 | 5 |
| 18 | 12.0 | La: 3.0, Pr: 12.0 | La, Pr | 27.0 | 0.87 | 5 |
| 19 | 12.0 | La: 3.0, Pr: 18.0 | La, Pr | 33.0 | 1.10 | 8 |
| 20 | 18.0 | 12.0 | Pr | 30.0 | 0.91 | 8 |
| 21 | 6.0 | 6.0 | Y | 12.0 | 0.72 | — |
| 22 | 12.0 | 3.0 | Y | 15.0 | 0.73 | — |
| 23 | 12.0 | 6.0 | Y | 18.0 | 0.74 | — |
| 24 | 12.0 | 12.0 | Y | 24.0 | 0.77 | — |
| 25 | 18.0 | 12.0 | Y | 30.0 | 0.80 | — |

Table 1 shows that Samples 5, 12 and 21 containing a combination of La, Pr or Y with Nd exhibited higher carbon burning rates than Samples 3 and 4 containing no Nd. Therefore, it is can be said to be preferable that Nd is an essential ingredient for the Zr-based mixed oxide. However, in the case where only Nd is used as the rare earth metal as in Samples 1 and 2, the carbon burning rate did not increase with increasing amount of Nd. Therefore, it can be said to be preferable that the Zr-based mixed oxide contains Nd in combination with La, Pr or Y.

Comparison among the cases where the proportion of rare earth metal M oxide is low (among Samples 7, 14 and 22 and among Samples 8, 15 and 23) shows that the use of La as the rare earth metal M is more advantageous than the use of Pr or Y in increasing the carbon burning rate. On the other hand, comparison among the cases where the proportion of rare earth metal M oxide is high (between Samples 6 and 13 and among Samples 11, 20 and 25) shows that the use of Pr as the rare earth metal M is more advantageous than the use of La or Y in increasing the carbon burning rate.

Furthermore, as the proportion of the total amount of neodymium oxide and M oxide increased, the carbon burning rate generally increased, with minor exceptions. However, as seen from the results of Samples 16 to 20, when the above total amount increased and the carbon burning rate increased accordingly, the amount of CO produced due to imperfect combustion of carbon tended to increase. Therefore, although it is advantageous in enhancing the particulate burning property that the proportion of the above total amount is high, the proportion is preferably not more than 45% by mole and more preferably not more than 40% by mole in order to restrain the increase in the amount of CO produced.

On the other hand, when the proportion of the above total amount reached 20% by mole or more, the carbon burning rate generally became high. Therefore, it can be said to be preferable that the proportion of the above total amount is not less than 20% by mole in enhancing the particulate burning property. Particularly, it is preferable to attain a proportion of the above total amount of 20% by mole or more while raising the proportion of neodymium oxide or praseodymium oxide.

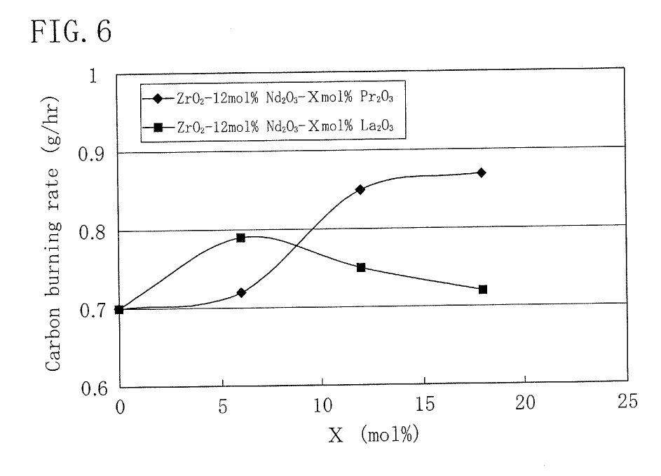

FIG. 6 shows results when samples obtained by coating different Zr-based mixed oxides using Pr or La as the rare earth metal M and containing no activated alumina on their respective SiC-made filter supports having the same cell wall thickness and number of cells but different from those of the samples in Table 1 were measured in terms of carbon burning rate at 590° C. under the same conditions as the above test on the samples in Table 1. Note that the proportion of Nd₂O₃ (hereinafter, referred to as “Nd₂O₃ ratio”) was fixed at 12% by mole because Table 1 shows that the Zr-based mixed oxide exhibited good results when its Nd₂O₃ ratio was 18% by mole or smaller. The filter body had a volume of 25 mL, a cell wall thickness of 12 mil and 300 cpsi. Furthermore, like the above test, the amount of each Zr-based mixed oxide powder carried per L of filter was 50 g/L and the amount of Pt carried per L of filter was 0.5 g/L. Each sample was heat aged by keeping it at 800° C. for 24 hours in the atmospheric environment.

FIG. 6 shows that it is preferable that the Zr-based mixed oxide uses Pr as the rare earth metal M and has a proportion of Pr₂O₃ of 6% by mole or higher in order to increase the carbon burning rate.

### <Preferred Composition of Catalyst Particle>

A description is given below of a preferred composition of the catalyst particle with reference to the following carbon burning property test using carbon particulates as particulates and the following exhaust gas (HC and CO) conversion performance test.

### —Preparation of Samples—

According to the above-stated method for preparing a catalyst material, various kinds of catalyst materials of inventive examples were prepared that have different proportions of ZrO₂ in Zr-based mixed oxide primary particle (ZrO₂/ZrNdMO shown in % by mole and hereinafter referred to as “ZrO₂ ratios”) and different proportions of Zr-based mixed oxide particles in the total amount of activated alumina particles (having a proportion of La₂O₃ of 5% by mass) and the Zr-based mixed oxide particles (hereinafter referred to as “ZrNdMO ratios”). Pr was used as the rare earth metal M for the Zr-based mixed oxide particle and the proportion of Pr₂O₃ (hereinafter referred to as “Pr₂O₃ ratio”) was fixed at 12% by mole. Furthermore, the catalytic metal Pt was carried on each support material by evaporation to dryness.

Furthermore, catalyst materials of comparative examples were obtained by preparing different kinds of Zr-based mixed oxide secondary particles having different ZrO₂ ratios and the same Pr₂O₃ ratio of 12% by mole by coprecipitation, physically mixing each of them with La-contained activated alumina secondary particles having a proportion of La₂O₃ of 5% by mass at an appropriate mixing ratio to obtain various kinds of powdered support materials and carrying Pt on each of them by evaporation to dryness.

Then, according to the previously stated method for preparing a sample, samples (catalyst-supported particulate filters) were obtained by coating the catalyst materials of the inventive examples and comparative examples on their respective SiC-made filter supports having a volume of 25 mL, a cell wall thickness of 12 mil and 300 cpsi. The amount of each catalyst material carried per L of filter was 50 g/L, and the amount of Pt carried per L of filter was 1.0 g/L. Then, each sample was heat aged by keeping it at 800° C. for 24 hours in the atmospheric environment.

### —Evaluation on Carbon Burning Property—

For each of the samples of the inventive examples and comparative examples, an amount of carbon (carbon black) corresponding to 10 g per L of filter was deposited on the walls of exhaust gas channels in the sample and the sample was then measured in terms of carbon burning rate at 590° C. according to the above-stated carbon burning property test.

The measurement results on the inventive examples and the measurement results on the comparative examples are shown in Tables 2 and 3, respectively.

Hereinafter, each of the samples of the inventive examples and comparative examples shown in Tables 2 and 3 was identified by the number of two places by placing the number for ZrO₂ ratio of the sample in the ten's place and placing the number for ZrNdMO ratio of the sample in the one place. For example, the inventive example having a ZrO₂ ratio of 75% by mole (corresponding to the number for the ratio, “2”) and a ZrNdMO ratio of 50% by mass (corresponding to the number for the ratio, “3”) is referred to as “Inventive Example 23”. This applies also to Tables 4 and 5 described later.

TABLE 2
Inventive Example; Carbon burning rate (g/hr, 590° C.)

| | | | ZrO₂/ZrNdMO ratio | | | |
|---|---|---|---|---|---|---|
| | | | No. 1 | No. 2 | No. 3 | No. 4 |
| | | | 55% by | 75% by | 80% by | 90% by |
| | | | mole | mole | mole | mole |
| ZrNdMO/ | No. 1 | 10% by | 0.94 | 0.87 | 0.82 | 0.77 |
| (ZrNdMO + | | mass | | | | |
| Al₂O₃) | No. 2 | 25% by | 1.05 | 0.94 | 0.86 | 0.79 |
| ratio | | mass | | | | |
| | No. 3 | 50% by | 1.01 | 0.9 | 0.85 | |
| | | mass | | | | |
| | No. 4 | 75% by | 0.92 | 0.86 | 0.82 | |
| | | mass | | | | |
| | No. 5 | 90% by | 0.85 | 0.79 | 0.8 | |
| | | mass | | | | |

Each of mixed oxide ZrNdMO and activated alumina is in the form of primary particles.

TABLE 3
Comparative Example; Carbon burning rate (g/hr, 590° C.)

| | | | ZrO₂/ZrNdMO ratio | | | |
|---|---|---|---|---|---|---|
| | | | No. 1 | No. 2 | No. 3 | No. 4 |
| | | | 55% by | 75% by | 80% by | 90% by |
| | | | mole | mole | mole | mole |
| ZrNdMO/ | No. 1 | 10% by | 0.95 | 0.87 | 0.85 | 0.79 |
| (ZrNdMO + | | mass | | | | |
| Al₂O₃) | No. 2 | 25% by | 0.96 | 0.9 | 0.875 | 0.82 |
| ratio | | mass | | | | |
| | No. 3 | 50% by | 0.91 | 0.86 | 0.8 | |
| | | mass | | | | |
| | No. 4 | 75% by | 0.82 | | | |
| | | mass | | | | |
| | No. 5 | 90% by | 0.75 | | | |
| | | mass | | | | |

Each of mixed oxide ZrNdMO and activated alumina is in the form of secondary particles.

Reference to Tables 2 and 3 shows that when the ZrO₂ ratio was 55% to 75% by mole, both inclusive, and the ZrNdMO ratio was 25% to 90% by mass, both inclusive, the inventive examples exhibited higher carbon burning rates than the comparative examples. The reason for these results can be considered to be that since in the inventive examples activated alumina and each kind of Zr-based mixed oxide were mixed together in the form of their primary particles of small particle size to form secondary particles each composed of a mixture of their primary particles, the amount of oxygen ions supplied by the Zr-based mixed oxide increased and the heat resistance of the catalyst material increased. Particularly, Inventive Example 12 (having a ZrO₂ ratio of 55% by mole and a ZrNdMO ratio of 25% by mass) exhibited a good result.

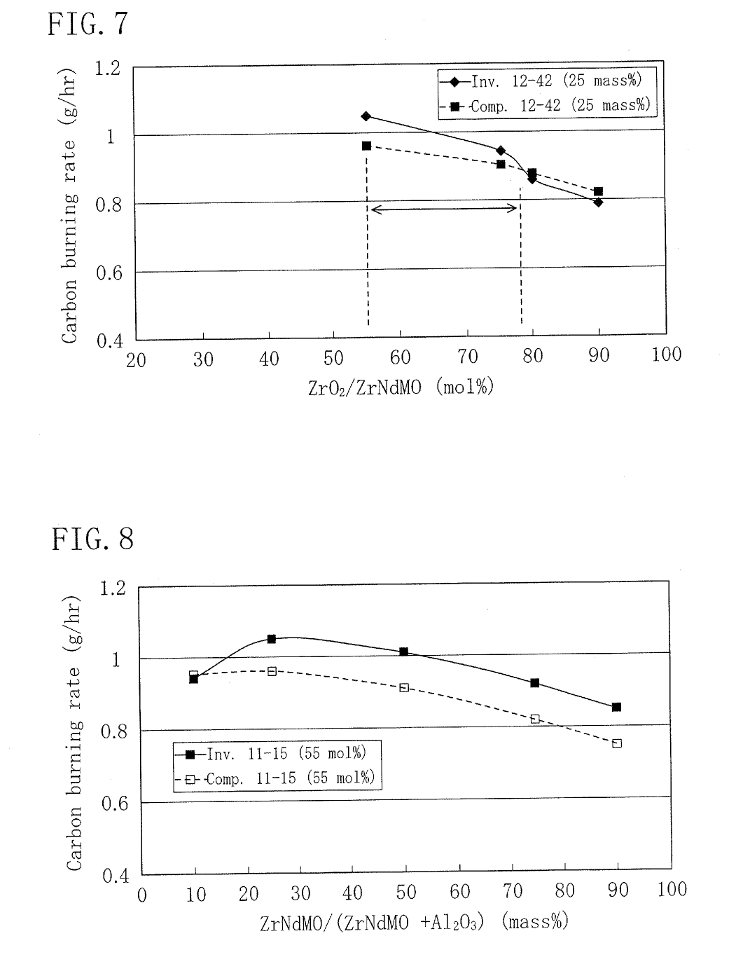

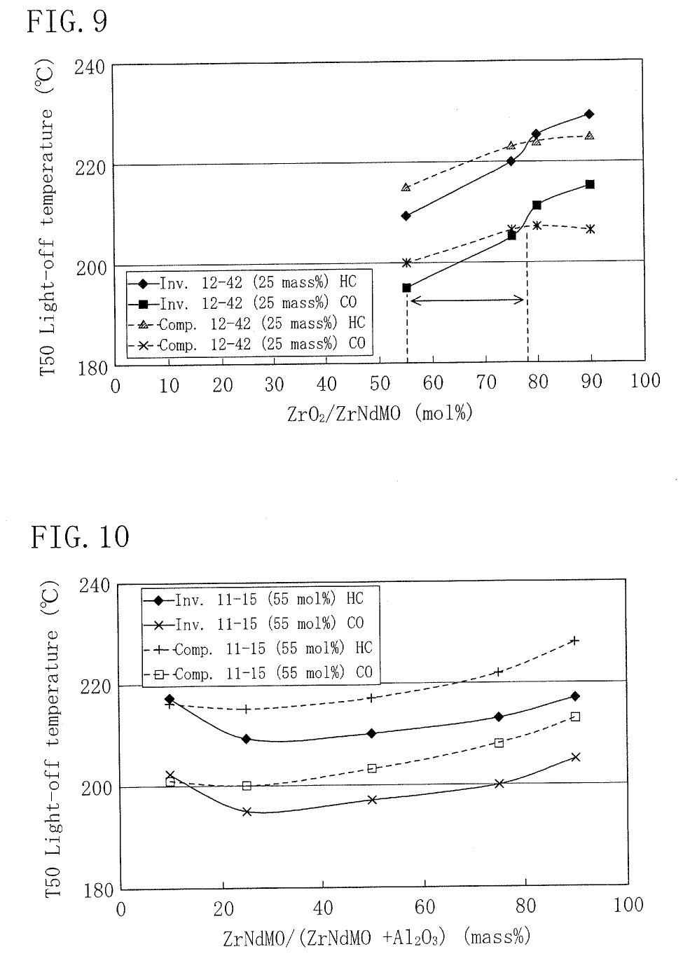

In this context, graphically shown in FIG. 7 are the carbon burning rates of Inventive Examples 12, 22, 32 and 42 and Comparative Examples 12, 22, 32 and 42 having a fixed ZrNdMO ratio of 25% by mass and different ZrO₂ ratios. Furthermore, graphically shown in FIG. 8 are the carbon burning rates of Inventive Examples 11 to 15 and Comparative Examples 11 to 15 having a fixed ZrO₂ ratio of 55% by mole and different ZrNdMO ratios. Note that in the graph of FIG. 7 “25% by mass” described in the window in which the classification of the characteristic lines is explained indicates the ZrNdMO ratio and that in the graph of FIG. 8 “55% by mole” described in the window in which the classification of the characteristic lines is explained indicates the ZrO₂ ratio. This applies also to FIGS. 9 and 10 described later.

Reference to FIG. 7 shows that when the ZrO₂ ratio was 55% to 78% by mole, both inclusive, the inventive examples had higher carbon burning rates than the comparative examples and that particularly when the ZrO₂ ratio was 55% to 75% by mole, both inclusive, the inventive examples exhibited relatively significant differences in carbon burning rate from the comparative examples.

Reference to FIG. 8 shows that when the ZrNdMO ratio was 25% to 90% by mass, both inclusive, the inventive examples had higher carbon burning rates than the comparative examples and that particularly when the ZrNdMO ratio was 25% to 50% by mass, both inclusive, the inventive examples exhibited relatively high carbon burning rates.

### —Evaluation of Light-off Performance for Exhaust Gas Conversion—

Each of the samples of the inventive examples and comparative examples was measured in terms of light-off performance for conversion of HC and CO in exhaust gas, unlike the above carbon burning property test, without deposition of carbon black. Specifically, the sample was set to a simulated gas flow reactor. In this state, simulated exhaust gas (composed of 10% O₂, 10% H₂O, 100 ppm NO, 200 ppmC C₃H₆, 400 ppm CO and N₂) was allowed to flow through the sample at a space velocity of 50000/h and, concurrently, the gas temperature at the catalyst sample entrance was increased at a rate of 15° C./min. Then obtained was the gas temperature T50 (° C.) at the catalyst sample entrance when the concentration of each of exhaust gas components (HC and CO) detected downstream of the sample reaches half of that of the corresponding exhaust gas component flowing into the sample (when the conversion efficiency reaches 50%). The measurement results on the inventive examples and the measurement results on the comparative examples are shown in Tables 4 and 5, respectively.

TABLE 4
Inventive Example; Light-off temperature T50 (° C.)

| | | | ZrO₂/ZrNdMO ratio | | | | | | | |
|---|---|---|---|---|---|---|---|---|---|---|
| | | | No. 1 | | No. 2 | | No. 3 | | No. 4 | |
| | | | 55% by | | 75% by | | 80% by | | 90% by | |
| | | | mole | | mole | | mole | | mole | |
| | | | HC | CO | HC | CO | HC | CO | HC | CO |
| ZrNdMO/ | No. 1 | 10% by | 217 | 202 | 226 | 211 | 230 | 218 | 234 | 218 |
| (ZrNdMO + | | mass | | | | | | | | |
| Al₂O₃) | No. 2 | 25% by | 209 | 195 | 220 | 205 | 225 | 211 | 229 | 215 |
| ratio | | mass | | | | | | | | |
| | No. 3 | 50% by | 210 | 197 | 223 | 209 | 226 | 213 | | |
| | | mass | | | | | | | | |
| | No. 4 | 75% by | 213 | 200 | 225 | 212 | 227 | 216 | | |
| | | mass | | | | | | | | |
| | No. 5 | 90% by | 217 | 205 | 228 | 212 | 229 | 218 | | |
| | | mass | | | | | | | | |

Each of mixed oxide ZrNdMO and activated alumina is in the form of primary particles.

TABLE 5
Comparative Example; Light-off temperature T50 (° C.)

| | | | ZrO₂/ZrNdMO ratio | | | | | | | |
|---|---|---|---|---|---|---|---|---|---|---|
| | | | No. 1 | | No. 2 | | No. 3 | | No. 4 | |
| | | | 55% by | | 75% by | | 80% by | | 90% by | |
| | | | mole | | mole | | mole | | mole | |
| | | | HC | CO | HC | CO | HC | CO | HC | CO |
| ZrNdMO/ | No. 1 | 10% by | 216 | 201 | 224 | 208 | 228 | 211 | 230 | 214 |
| (ZrNdMO + | | mass | | | | | | | | |
| Al₂O₃) | No. 2 | 25% by | 215 | 200 | 223 | 206 | 224 | 207 | 225 | 206 |
| ratio | | mass | | | | | | | | |
| | No. 3 | 50% by | 217 | 203 | 224 | 211 | 228 | 214 | | |
| | | mass | | | | | | | | |
| | No. 4 | 75% by | 222 | 208 | | | | | | |
| | | mass | | | | | | | | |
| | No. 5 | 90% by | 228 | 213 | | | | | | |
| | | mass | | | | | | | | |

Each of mixed oxide ZrNdMO and activated alumina is in the form of secondary particles.

Reference to Tables 4 and 5 shows that when the ZrO₂ ratio was 55% to 75% by mole, both inclusive, and the ZrNdMO ratio was 25% to 90% by mass, both inclusive, the inventive examples exhibited lower light-off temperatures than the comparative examples. The reason for these results can also be deemed to be that the catalyst materials of the inventive examples had higher oxygen ion conductivity and higher heat resistance than those of the comparative examples.

Graphically shown in FIG. 9 are the light-off temperatures of Inventive Examples 12, 22, 32 and 42 and Comparative Examples 12, 22, 32 and 42 having a fixed ZrNdMO ratio of 25% by mass and different ZrO₂ ratios. Furthermore, graphically shown in FIG. 10 are the light-off temperatures of Inventive Examples 11 to 15 and Comparative Examples 11 to 15 having a fixed ZrO₂ ratio of 55% by mole and different ZrNdMO ratios.

Reference to FIG. 9 shows that when the ZrO₂ ratio was 55% to 78% by mole, both inclusive, the inventive examples had lower light-off temperatures for both of HC and CO than the comparative examples and that particularly when the ZrO₂ ratio was 55% to 75% by mole, both inclusive, the inventive examples exhibited low light-off temperatures.

Reference to FIG. 10 shows that when the ZrNdMO ratio was 25% to 90% by mass, both inclusive, the inventive examples had lower light-off temperatures than the comparative examples and that particularly when the ZrNdMO ratio was 25% to 50% by mass, both inclusive, the inventive examples exhibited relatively low light-off temperatures.

### Embodiment 2

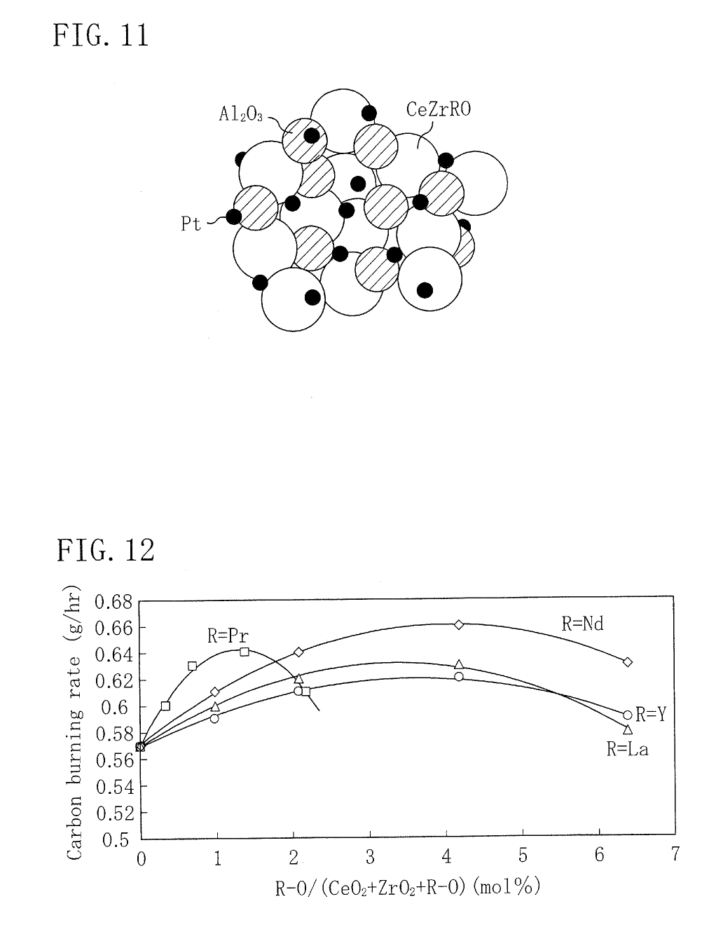

A feature of this embodiment is that the catalyst layer 7 shown in FIG. 4 contains catalyst particles (a catalyst material) as schematically shown in FIG. 11. Specifically, the catalyst particle is a secondary particle formed so that primary particles of activated alumina (hatched particles; Al₂O₃) and primary particles of a Ce-based mixed oxide that contains Ce, Zr and a rare earth metal R other than Ce (particles indicated by unfilled circles; CeZrRO) are mixed and cohere together. Pt particles (indicated by filled circles) are carried as a catalytic metal on each primary particle of activated alumina (Al₂O₃) and each primary particle of the Ce-based mixed oxide (CeZrRO). The primary particles of activated alumina have a mean particle size of 1 to 100 nm and the primary particles of the Ce-based mixed oxide have a mean particle size of 5 to 100 mn.

### <Preparation of Catalyst Material>

The catalyst material can be prepared according to the following method.

### —Preparation of Activated Alumina Particle Precursor—

A precursor of activated alumina particles can be prepared in the same manner as in Embodiment 1.

### —Preparation of Ce-Based Mixed Oxide Particle Precursor—

First, an acid solution containing Ce ions, Zr ions and ions of a rare earth metal R other than Ce is prepared. Cerium nitrate (III) hexahydrate and Zirconium oxynitrate dihydrate can be used as source materials for Ce and Zr, respectively. A nitrate salt of Nd, La, Pr or Y can be used as a source material for the rare earth metal R other than Ce. Respective given amounts of the Ce source material, the Zr source material and the R source material are mixed with water to prepare a source solution having acidity.

A basic solution is added to the source solution and mixed to produce precipitated particles of a Ce—Zr—R mixed hydroxide that is a precursor of Ce-based mixed oxide primary particles. In this case, for example, the source solution is stirred at room temperature for about one hour and aqueous ammonia at a concentration of about 7%, for example, is then mixed as the basic solution to the source solution. Instead of the aqueous ammonia, another basic solution, such as an aqueous solution of caustic soda, may be used.

### —Other Steps for Preparation of Catalyst Material—

The other steps following the above steps, i.e., the step of mixing the activated alumina particle precursor and the Ce-based mixed oxide particle precursor, the rinsing and dehydration step, the drying and calcining step and the step of carrying a catalytic metal, are carried out in the same manner as in Embodiment 1.

Thus, a catalyst material composed of catalyst particles as shown in FIG. 11 is obtained.

### <Preferred Ce-Based Mixed Oxide Particle>

A description is given below of a preferred composition of the Ce-based mixed oxide particle with reference to the following carbon burning property test in which carbon particulates were used as particulates.

### —Preparation of Samples—

Prepared were various kinds of powdered Ce-based mixed oxides (CeZrRO) containing different kinds and proportions of rare earth metals R. The molar ratio between CeO₂ and ZrO₂ was 1:3. First, Pt-carried catalyst materials were prepared by mixing each kind of mixed oxide powder with a solution of diamminedinitro platinum nitrate and ion-exchanged water, evaporating the mixture to dryness, then well drying it and calcining it at 500° C. for two hours in the atmospheric environment. Note that the catalyst materials contained no activated alumina.

Then, samples (catalyst-supported particulate filters) were obtained by mixing each of the obtained catalyst materials with a binder and ion-exchanged water into a slurry, coating the slurry on a support (filter body) for a filter made of SiC having a volume of 25 mL, a cell wall thickness of 12 mil (304.8×10⁻³ mm) and 300 cpsi (i.e., the number of cells per square inch (645.16 mm²)), then drying it and calcining it by keeping it at 500° C. for two hours in the atmospheric environment. The amount of each Ce-based mixed oxide powder carried per L of filter was 50 g/L, and the amount of Pt carried per L of filter was 0.5 g/L. Then, each sample was heat aged by keeping it at 800° C. for 24 hours in the atmospheric environment.

Next, like Embodiment 1, an amount of carbon corresponding to 10 g per L of filter was deposited on the walls of exhaust gas channels in each sample and the sample was then measured in terms of carbon burning rate at 590° C. under the same conditions as in Embodiment 1.

The measurement results are shown in FIG. 12. The abscissa of FIG. 12 represents the proportion (% by mole) of rare earth metal oxide R—O in each Ce-based mixed oxide.

FIG. 12 shows that when the rare earth metal R was Pr, relatively high carbon burning rates were reached at small proportions of the rare earth metal oxide R—O of 0.3% to 2% by mole and that when the rare earth metal R was Nd, La or Y, relatively high carbon burning rates were reached at proportions of the rare earth metal oxide R—O of 1% to 7% by mole or 1% to 6% by mole. Furthermore, it can be said that, among the four kinds of rare earth metals, the use of Nd is most advantageous in enhancing the carbon burning property and that the Nd₂O₃ ratio is preferably 4% by mole.

### <Preferred Composition of Catalyst Particle>

A description is given below of a preferred composition of the catalyst particle with reference to the following carbon burning property test using carbon particulates as particulates and the following exhaust gas (HC and CO) conversion performance test.

### —Preparation of Samples—

According to the above-stated method for preparing a catalyst material, various kinds of catalyst materials of inventive examples were prepared that have different proportions of CeCO₂ in Ce-based mixed oxide primary particle (CeO₂/CeZrRO shown in % by mole and hereinafter referred to as “CeO₂ ratios”) and different proportions of Ce-based mixed oxide particles in the total amount of activated alumina particles (having a proportion of La₂O₃ of 5% by mass) and the Ce-based mixed oxide particles (hereinafter referred to as “CeZrRO ratios”). Nd was used as the rare earth metal R for the Ce-based mixed oxide particle and the Nd₂O₃ ratio was fixed at 4% by mole. Furthermore, the catalytic metal Pt was carried on each support material by evaporation to dryness.

Furthermore, catalyst materials of comparative examples were obtained by preparing different kinds of Ce-based mixed oxide secondary particles having different CeO₂ ratios and the same Nd₂O₃ ratio of 4% by mole by coprecipitation, physically mixing each of them with La-contained activated alumina secondary particles having a proportion of La₂O₃ of 5% by mass at an appropriate mixing ratio to obtain various kinds of powdered support materials and carrying Pt on each of them by evaporation to dryness.

Then, according to the previously stated method for preparing a sample, samples (catalyst-supported particulate filters) were obtained by coating the catalyst materials of the inventive examples and comparative examples on their respective SiC-made filter supports having a volume of 25 mL, a cell wall thickness of 12 mil and 300 cpsi. The amount of each catalyst material carried per L of filter was 50 g/L, and the amount of Pt carried per L of filter was 1.0 g/L. Then, each sample was heat aged by keeping it at 800° C. for 24 hours in the atmospheric environment.

### —Evaluation on Carbon Burning Property—

For each of the samples of the inventive examples and comparative examples, an amount of carbon (carbon black) corresponding to 10 g per L of filter was deposited on the walls of exhaust gas channels in the sample and the sample was then measured in terms of carbon burning rate at 590° C. according to the above-stated carbon burning property test.

The measurement results on the inventive examples and the measurement results on the comparative examples are shown in Tables 6 and 7, respectively.

Hereinafter, each of the samples of the inventive examples and comparative examples shown in Tables 6 and 7 was identified by the number of two places by placing the number for CeO₂ ratio of the sample in the ten's place and placing the number for CeZrRO ratio of the sample in the one place. For example, the inventive example having a CeO₂ ratio of 45% by mole (corresponding to the number for the ratio, “3”) and a CeZrRO ratio of 25% by mass (corresponding to the number for the ratio, “2”) is referred to as “Inventive Example 32”.

This applies also to Tables 8 and 9 described later.

TABLE 6
Inventive Example; Carbon burning rate (g/hr, 590° C.)

| | | | CeO₂/CeZrRO ratio | | | | |
|---|---|---|---|---|---|---|---|
| | | | | | No. 3 | | No. 5 |
| | | | No. 1 | No. 2 | 45% | No. 4 | 80% |
| | | | 10% by | 20% by | by | 60% by | by |
| | | | mole | mole | mole | mole | mole |
| CeZrRO/ | No. 1 | 10% by | | 0.8 | 0.82 | 0.8 | |
| (CeZrRO + | | mass | | | | | |
| Al₂O₃) | No. 2 | 25% by | 0.75 | 0.81 | 0.825 | 0.805 | 0.76 |
| ratio | | mass | | | | | |
| | No. 3 | 50% by | | 0.79 | 0.81 | 0.79 | |
| | | mass | | | | | |
| | No. 4 | 75% by | | 0.77 | 0.78 | 0.76 | |
| | | mass | | | | | |
| | No. 5 | 90% by | | 0.71 | 0.72 | 0.72 | |
| | | mass | | | | | |

Each of mixed oxide CeZrRO and activated alumina is in the form of primary particles.

TABLE 7
Comparative Example; Carbon burning rate (g/hr, 590° C.)

| | | | CeO₂/CeZrRO ratio | | | | |
|---|---|---|---|---|---|---|---|
| | | | | | No. 3 | | No. 5 |
| | | | No. 1 | No. 2 | 45% | No. 4 | 80% |
| | | | 10% by | 20% by | by | 60% by | by |
| | | | mole | mole | mole | mole | mole |
| CeZrRO/ | No. 1 | 10% by | | 0.79 | 0.81 | 0.79 | |
| (CeZrRO + | | mass | | | | | |
| Al₂O₃) | No. 2 | 25% by | 0.765 | 0.795 | 0.81 | 0.8 | 0.77 |
| ratio | | mass | | | | | |
| | No. 3 | 50% by | | | 0.785 | | |
| | | mass | | | | | |
| | No. 4 | 75% by | | | 0.76 | | |
| | | mass | | | | | |
| | No. 5 | 90% by | | | 0.7 | | |
| | | mass | | | | | |

Each of mixed oxide CeZrRO and activated alumina is in the form of secondary particles.

Reference to Tables 6 and 7 shows that at all of CeO₂ ratios and CeZrRO ratios but CeO₂ ratios of 10% by mole and 80% by mole, the inventive examples exhibited higher carbon burning rates than the comparative examples. The reason for these results can be considered to be that since in the inventive examples activated alumina and each kind of Ce-based mixed oxide were mixed together in the form of their primary particles of small particle size to form secondary particle each composed of a mixture of their primary particles, the oxygen storage/release capacity of the Ce-based mixed oxide increased and the heat resistance of the catalyst material increased. Particularly, Inventive Example 32 (having a CeO₂ ratio of 45% by mole and a CeZrRO ratio of 25% by mass) exhibited a good result.

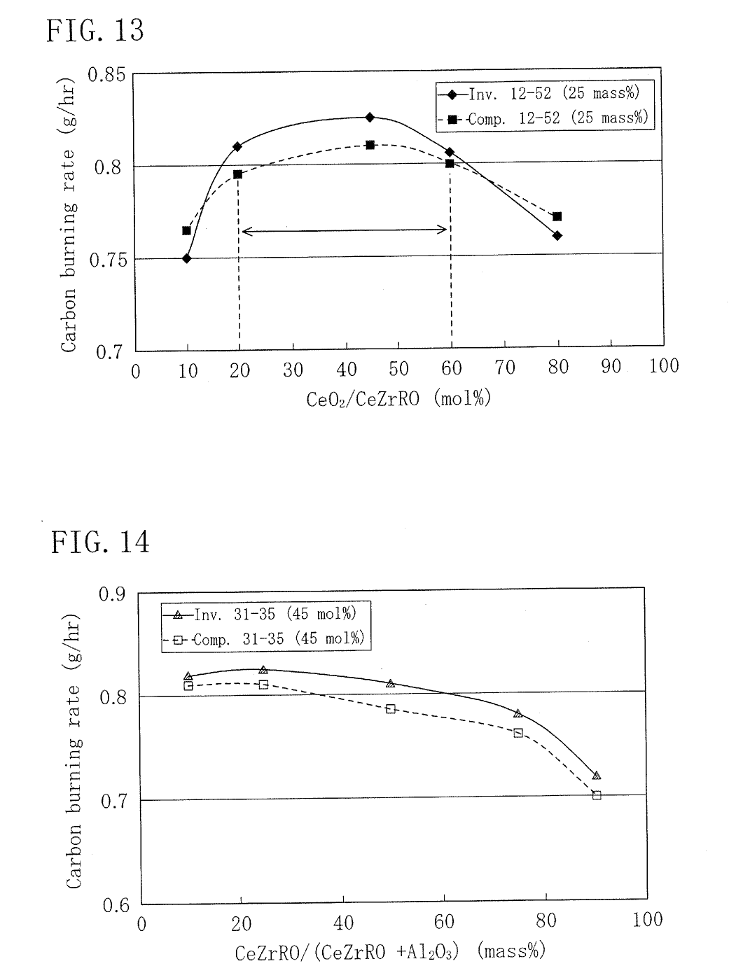

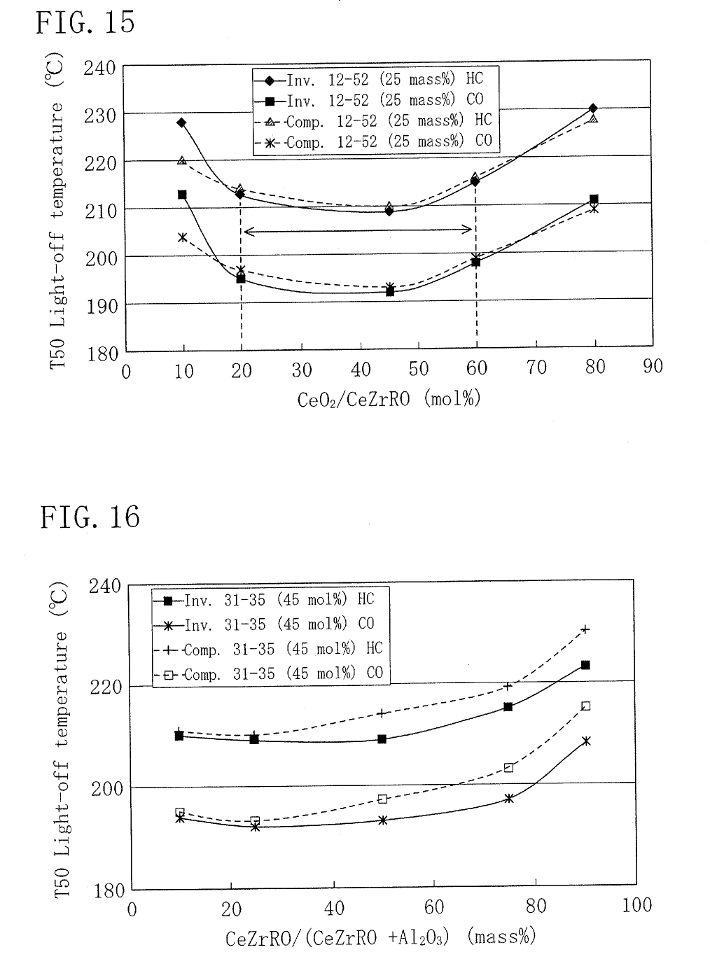

In this context, graphically shown in FIG. 13 are the carbon burning rates of Inventive Examples 12, 22, 32, 42 and 52 and Comparative Examples 12, 22, 32, 42 and 52 having a fixed CeZrRO ratio of 25% by mass and different CeO₂ ratios. Furthermore, graphically shown in FIG. 14 are the carbon burning rates of Inventive Examples 31 to 35 and Comparative Examples 31 to 35 having a fixed CeO₂ ratio of 45% by mole and different CeZrRO ratios. Note that in the graph of FIG. 13 “25% by mass” described in the window in which the classification of the characteristic lines is explained indicates the CeZrRO ratio and that in the graph of FIG. 14 “45% by mole” described in the window in which the classification of the characteristic lines is explained indicates the CeO₂ ratio. This applies also to FIGS. 15 and 16 described later.

Reference to FIG. 13 shows that when the CeO₂ ratio was 20% to 60% by mole, both inclusive, the inventive examples had higher carbon burning rates than the comparative examples and that particularly when the CeO₂ ratio was 20% to 45% by mole, both inclusive, the inventive examples exhibited relatively significant differences in carbon burning rate from the comparative examples.

Reference to FIG. 14 shows that when the CeZrRO ratio was 10% to 90% by mass, both inclusive, the inventive examples had higher carbon burning rates than the comparative examples and that particularly when the CeZrRO ratio was 10% to 75% by mass, both inclusive, the inventive examples exhibited relatively high carbon burning rates.

### —Evaluation of Light-off Performance for Exhaust Gas Conversion—

Each of the samples of the inventive examples and comparative examples was measured in terms of light-off performance for conversion of HC and CO in exhaust gas in the same manner as the light-off performance test in Embodiment 1 without deposition of carbon black.

The measurement results on the inventive examples and the measurement results on the comparative examples are shown in Tables 8 and 9, respectively.

TABLE 8
Inventive Example; Light-off temperature T50 (° C.)

| | | | CeO₂/CeZrRO ratio | | | | | | | | | |
|---|---|---|---|---|---|---|---|---|---|---|---|---|
| | | | No. 1 | | No. 2 | | No. 3 | | No. 4 | | No. 5 | |
| | | | 10% by | | 20% by | | 45% by | | 60% by | | 80% by | |
| | | | mole | | mole | | mole | | mole | | mole | |
| | | | HC | CO | HC | CO | HC | CO | HC | CO | HC | CO |
| CeZrRO/ | No. 1 | 10% by | | | 214 | 198 | 210 | 194 | 217 | 201 | | |
| (CeZrRO + | | mass | | | | | | | | | | |
| Al₂O₃) | No. 2 | 25% by | 228 | 213 | 213 | 195 | 209 | 192 | 215 | 198 | 230 | 211 |
| ratio | | mass | | | | | | | | | | |
| | No. 3 | 50% by | | | 211 | 195 | 209 | 193 | 217 | 202 | | |
| | | mass | | | | | | | | | | |
| | No. 4 | 75% by | | | 219 | 200 | 215 | 197 | 222 | 205 | | |
| | | mass | | | | | | | | | | |
| | No. 5 | 90% by | | | 225 | 208 | 223 | 208 | 227 | 209 | | |
| | | mass | | | | | | | | | | |

Each of mixed oxide CeZrRO and activated alumina is in the form of primary particles.

TABLE 9
Comparative Example; Light-off temperature T50 (° C.)

| | | | CeO₂/CeZrRO ratio | | | | | | | | | |
|---|---|---|---|---|---|---|---|---|---|---|---|---|
| | | | No. 1 | | No. 2 | | No. 3 | | No. 4 | | No. 5 | |
| | | | 10% by | | 20% by | | 45% by | | 60% by | | 80% by | |
| | | | mole | | mole | | mole | | mole | | mole | |
| | | | HC | CO | HC | CO | HC | CO | HC | CO | HC | CO |
| CeZrRO/ | No. 1 | 10% by | | | 215 | 199 | 211 | 195 | 215 | 200 | | |
| (CeZrRO + | | mass | | | | | | | | | | |
| Al₂O₃) | No. 2 | 25% by | 220 | 204 | 214 | 197 | 210 | 193 | 216 | 199 | 228 | 209 |
| ratio | | mass | | | | | | | | | | |
| | No. 3 | 50% by | | | | | 214 | 197 | | | | |
| | | mass | | | | | | | | | | |
| | No. 4 | 75% by | | | | | 219 | 203 | | | | |
| | | mass | | | | | | | | | | |
| | No. 5 | 90% by | | | | | 230 | 215 | | | | |
| | | mass | | | | | | | | | | |

Each of mixed oxide CeZrRO and activated alumina is in the form of secondary particles.

Reference to Tables 8 and 9 shows that at all of CeO₂ ratios and CeZrRO ratios but CeO₂ ratios of 10% by mole and 80% by mole and CO in Inventive Example 41, the inventive examples exhibited lower light-off temperatures than the comparative examples. The reason for these results can also be deemed to be that the catalyst materials of the inventive examples had higher oxygen storage/release capacity and higher heat resistance than those of the comparative examples.

Graphically shown in FIG. 15 are the light-off temperatures of Inventive Examples 12, 22, 32, 42 and 52 and Comparative Examples 12, 22, 32, 42 and 52 having a fixed CeZrRO ratio of 25% by mass and different CeO₂ ratios. Furthennore, graphically shown in FIG. 16 are the light-off temperatures of Inventive Examples 31 to 35 and Comparative Examples 31 to 35 having a fixed CeO₂ ratio of 45% by mole and different CeZrRO ratios.

Reference to FIG. 15 shows that when the CeO₂ ratio was 20% to 60% by mole, both inclusive, the inventive examples had lower light-off temperatures for both of HC and CO than the comparative examples and that particularly when the CeO₂ ratio was 20% to 45% by mole, both inclusive, the inventive examples exhibited low light-off temperatures.

Reference to FIG. 16 shows that when the CeZrRO ratio was 10% to 90% by mass, both inclusive, the inventive examples had lower light-off temperatures than the comparative examples and that particularly when the CeZrRO ratio was 10% to 75% by mass, both inclusive, the inventive examples exhibited relatively low light-off temperatures.

### Embodiment 3

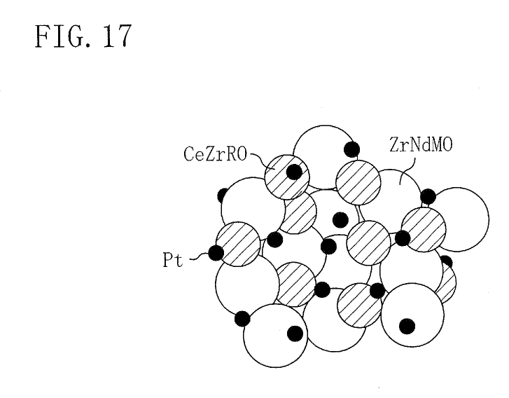

A feature of this embodiment is that the catalyst layer 7 shown in FIG. 4 contains catalyst particles (a catalyst material) as schematically shown in FIG. 17. Specifically, the catalyst particle is a secondary particle formed so that primary particles of a Ce-based mixed oxide containing Ce, Zr and a rare earth metal R other than Ce (hatched particles; CeZrRO) and primary particles of a Zr-based mixed oxide that contains Zr and a rare earth metal Z containing no Ce and composed of Nd and a rare earth metal M other than Ce and Nd (particles indicated by unfilled circles; ZrNdMO) are mixed and cohere together. Pt particles (indicated by filled circles) are carried as a catalytic metal on each primary particle of the Ce-based mixed oxide (CeZrRO) and each primary particle of the Zr-based mixed oxide (ZrNdMO). The primary particles of the Ce-based mixed oxide have a mean particle size of 5 to 100 nm and the primary particles of the Zr-based mixed oxide have a mean particle size of 5 to 50 nm.

### <Preparation of Catalyst Material>

The catalyst material can be prepared according to the following method.

### —Preparation of Zr-Based Mixed Oxide Particle Precursor—

A precursor of the Zr-based mixed oxide particles can be prepared in the same manner as in Embodiment 1.

### —Preparation of Ce-Based Mixed Oxide Particle Precursor—

A precursor of the Ce-based mixed oxide particles can be prepared in the same manner as in Embodiment 2.

### —Other Steps for Preparation of Catalyst Material—

The other steps following the above steps, i.e., the step of mixing the Zr-based mixed oxide particle precursor and the Ce-based mixed oxide particle precursor, the rinsing and dehydration step, the drying and calcining step and the step of carrying a catalytic metal, are carried out in the same manner as in Embodiment 1.

Thus, a catalyst material composed of catalyst particles as shown in FIG. 17 is obtained.

### <Preferred Zr-Based Mixed Oxide Particle>

A preferred composition of the Zr-based mixed oxide particle is the same as that in Embodiment 1 (see Table 1). Therefore, it is preferable that the Zr-based mixed oxide particle contains Nd as an essential component in combination with La, Pr or Y. In the cases where the proportion of rare earth metal M oxide is low, the use of La as the rare earth metal M is advantageous in increasing the carbon burning rate. On the other hand, in the cases where the proportion of rare earth metal M oxide is high, the use of Pr as the rare earth metal M is advantageous in increasing the carbon burning rate. Furthermore, the proportion of the total amount of neodymium oxide and M oxide is preferably not less than 20% by mole in enhancing the particulate burning property. Particularly, it is preferable to attain a proportion of the above total amount of 20% by mole or more while raising the proportion of neodymium oxide or praseodymium oxide. On the other hand, the proportion of the above total amount is preferably not more than 45% by mole and more preferably not more than 40% by mole in order to restrain the amount of CO produced from increasing owing to imperfect combustion of carbon. Furthermore, it is preferable that the Zr-based mixed oxide uses Pr as the rare earth metal M and has a Pr₂O₃ ratio of 6% by mole or higher in order to increase the carbon burning rate (see FIG. 6).

### <Preferred Ce-Based Mixed Oxide Particle>

A preferred composition of the Ce-based mixed oxide particle is the same as that in Embodiment 2 (see FIG. 12). Specifically, when the Ce-based mixed oxide particles used Pr as the rare earth metal R, relatively high carbon burning rates were reached at small proportions of the rare earth metal oxide R—O of 0.3% to 2% by mole. When the Ce-based mixed oxide particles used another rare earth metal, such as Nd, La or Y, relatively high carbon burning rates were reached at proportions of the rare earth metal oxide R—O of 1% to 7% by mole or 1% to 6% by mole. Furthermore, among the four kinds of rare earth metals, the use of Nd is most advantageous in enhancing the carbon burning property and the Nd₂O₃ ratio is preferably 4% by mole.

### <Preferred Composition of Catalyst Particle>

### —Preparation of Samples—

According to the above-stated method for preparing a catalyst material, various kinds of catalyst materials of inventive examples were prepared that have different proportions of ZrO₂ in Zr-based mixed oxide primary particle (ZrO₂/ZrNdMO shown in % by mole) and different proportions of CeO₂ in Ce-based mixed oxide primary particle (CeO₂/CeZrRO shown in % by mole). Pr was used as the rare earth metal M for the Zr-based mixed oxide particle and the Pr₂O₃ ratio was fixed at 12% by mole. Nd was used as the rare earth metal R for the Ce-based mixed oxide particle and the Nd₂O₃ ratio was fixed at 4% by mole. Furthermore, the catalytic metal Pt was carried on each support material by evaporation to dryness. The proportion of Ce-based mixed oxide particles in the total amount of Zr-based mixed oxide particles and the Ce-based mixed oxide particles (hereinafter, referred to as “CeZrRO ratios”) was fixed at 33% by mass.

Catalyst materials of comparative examples were prepared in the following manner. Specifically, different kinds of Zr-based mixed oxide secondary particles having different ZrO₂ ratios and the same Pr₂O₃ ratio of 12% by mole and different kinds of Ce-based mixed oxide secondary particles having different CeO₂ ratios and the same Nd₂O₃ ratio of 4% by mole were each prepared by coprecipitation. The obtained each kind of Zr-based mixed oxide secondary particles and each kind of Ce-based mixed oxide secondary particles were physically mixed so that the proportion of the Ce-based mixed oxide secondary particles in the total amount of both kinds of secondary particles was 33% by mass, thereby obtaining various kinds of powdered support materials. Then, Pt was carried on each of the powdered support materials by evaporation to dryness to obtain various kinds of catalyst materials of comparative examples.

Then, according to the method for preparing a sample described in the former embodiments, samples (catalyst-supported particulate filters) were obtained by coating the catalyst materials of the inventive examples and comparative examples on their respective SiC-made filter supports having a volume of 25 mL, a cell wall thickness of 12 mil and 300 cpsi. The amount of each catalyst material carried per L of filter was 50 g/L, and the amount of Pt carried per L of filter was 1.0 g/L. Then, each sample was heat aged by keeping it at 800° C. for 24 hours in the atmospheric environment.

### —Evaluation on Carbon Burning Property—

For each of the samples of the inventive examples and comparative examples, an amount of carbon (carbon black) corresponding to 10 g per L of filter was deposited on the walls of exhaust gas channels in the sample and the sample was then measured in terms of carbon burning rate at 590° C. according to the above-stated carbon burning property test.

The measurement results on the inventive examples and the measurement results on the comparative examples are shown in Tables 10 and 11, respectively.

TABLE 10
Inventive Example; Carbon burning rate (g/hr, 590° C.)

| | | | ZrO₂/ZrNdMO ratio | | | |
|---|---|---|---|---|---|---|
| | | | No. 1 | No. 2 | No. 3 | No. 4 |
| | | | 55% by | 75% by | 80% by | 90% by |
| | | | mole | mole | mole | mole |
| CeO₂/ | No. 1 | 10% by | 0.925 | 0.89 | 0.85 | |
| CeZrRO | | mole | | | | |
| ratio | No. 2 | 20% by | 1.1 | 0.97 | 0.86 | 0.76 |
| | | mole | | | | |
| | No. 3 | 45% by | 1.15 | 0.93 | 0.84 | 0.74 |
| | | mole | | | | |
| | No. 4 | 60% by | 0.92 | 0.88 | 0.81 | |
| | | mole | | | | |
| | No. 5 | 80% by | 0.91 | 0.82 | | |
| | | mole | | | | |

Each of mixed oxide CeZrRO and mixed oxide ZrNdMO is in the form of primary particles.

TABLE 11
Comparative Example; Carbon burning rate (g/hr, 590° C.)

| | | | ZrO₂/ZrNdMO ratio | | | |
|---|---|---|---|---|---|---|
| | | | No. 1 | No. 2 | No. 3 | No. 4 |
| | | | 55% by | 75% by | 80% by | 90% by |
| | | | mole | mole | mole | mole |
| CeO₂/ | No. 1 | 10% by | 0.935 | 0.9 | | |
| CeZrRO | | mole | | | | |
| ratio | No. 2 | 20% by | 0.945 | 0.89 | 0.87 | |
| | | mole | | | | |
| | No. 3 | 45% by | 0.95 | 0.86 | | |
| | | mole | | | | |
| | No. 4 | 60% by | 0.94 | | | |
| | | mole | | | | |
| | No. 5 | 80% by | 0.92 | | | |
| | | mole | | | | |

Each of mixed oxide CeZrRO and mixed oxide ZrNdMO is in the form of secondary particles.

Reference to Tables 10 and 11 shows that when the ZrO₂ ratio was 55% to 75% by mole, both inclusive, and the CeO₂ ratio was 20% to 45% by mole, both inclusive, the inventive examples exhibited higher carbon burning rates than the comparative examples. The reason for these results can be considered to be that since in the inventive examples each kind of Zr-based mixed oxide and each kind of Ce-based mixed oxide were mixed together in the form of their primary particles of small particle size to form secondary particles each composed of a mixture of their primary particles, the oxygen ion conductivity of the Zr-based mixed oxide and the oxygen storage/release capacity of the Ce-based mixed oxide increased and the heat resistance of the catalyst material increased. Particularly, the inventive example having a ZrO₂ ratio of 55% by mole and a CeO₂ ratio of 20% by mole and the inventive example having a ZrO₂ ratio of 55% by mole and a CeO₂ ratio of 45% by mole exhibited good results.

In this contest, various kinds of catalyst samples were prepared by changing the CeZrRO ratio of the inventive and comparative examples, each composed of a Zr-based mixed oxide having a ZrO₂ ratio of 55% by mole and a Ce-based mixed oxide having a CeO₂ ratio of 20% by mole, to 20%, 33%, 50%, 66% and 75% by mass. Then, each of the samples of the inventive examples and comparative examples was heat aged like the case of Tables 10 and 11, carbon was deposited on the walls of exhaust gas channels in the sample like the case of Tables 10 and 11 and the sample was then measured in terms of carbon burning rate at 590° C. according to the above-stated carbon burning property test.

The filter support for each sample, the amount of catalyst material carried per L of filter and the amount of Pt carried per L of filter were the same as in the case of Tables 2 and3.

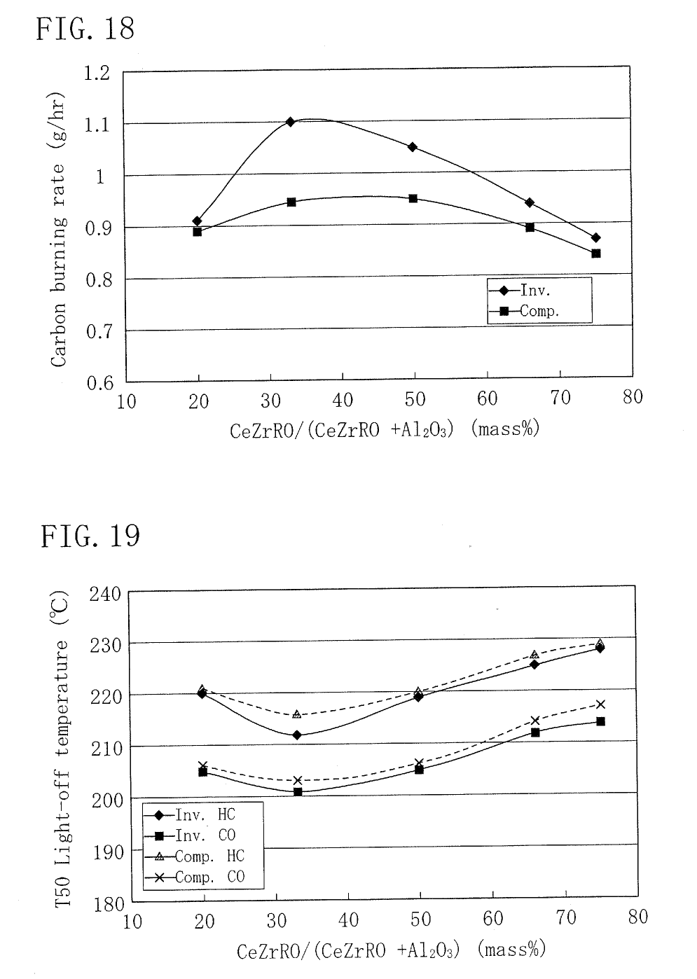

The measurement results are shown in FIG. 18. Reference to FIG. 18 shows that the inventive examples had higher carbon burning rates than the comparative examples and that when the CeZrRO ratio was 25% to 75% by mass, both inclusive, the inventive examples exhibited high carbon burning rates, which is advantageous in burning particulates. More preferably, the CeZrRO ratio is 25% to 65% by mass, both inclusive.

### —Evaluation of Light-off Performance for Exhaust Gas Conversion—

Each of the samples of the inventive and comparative examples, which are the same as shown in Tables 10 and 11 but have a fixed CeZrRO ratio of 33% by mass, was measured in terms of light-off performance for conversion of HC and CO in exhaust gas in the same manner as the light-off performance test in Embodiment 1 without deposition of carbon black.

The measurement results on the inventive examples and the measurement results on the comparative examples are shown in Tables 12 and 13, respectively.

TABLE 12
Inventive Example; Light-off temperature T50 (° C.)

| | | | ZrO₂/ZrNdMO ratio | | | | | | | |
|---|---|---|---|---|---|---|---|---|---|---|
| | | | No. 1 | | No. 2 | | No. 3 | | No. 4 | |
| | | | 55% by | | 75% by | | 80% by | | 90% by | |
| | | | mole | | mole | | mole | | mole | |
| | | | HC | CO | HC | CO | HC | CO | HC | CO |
| CeO₂/ | No. 1 | 10% by | 219 | 206 | 225 | 211 | | | | |
| CeZrRO | | mole | | | | | | | | |
| ratio | No. 2 | 20% by | 212 | 201 | 216 | 202 | 228 | 215 | 231 | 217 |
| | | mole | | | | | | | | |
| | No. 3 | 45% by | 211 | 200 | 214 | 200 | 229 | 209 | 229 | 216 |
| | | mole | | | | | | | | |
| | No. 4 | 60% by | 220 | 208 | 225 | 211 | 229 | 214 | | |
| | | mole | | | | | | | | |
| | No. 5 | 80% by | 231 | 218 | 233 | 218 | | | | |
| | | mole | | | | | | | | |

Each of mixed oxide CeZrRO and mixed oxide ZrNdMO is in the form of primary particles.

TABLE 13
Comparative Example; Light-off temperature T50 (° C.)

| | | | ZrO₂/ZrNdMO ratio | | | | | | | |
|---|---|---|---|---|---|---|---|---|---|---|
| | | | No. 1 | | No. 2 | | No. 3 | | No. 4 | |
| | | | 55% by | | 75% by | | 80% by | | 90% by | |
| | | | mole | | mole | | mole | | mole | |
| | | | HC | CO | HC | CO | HC | CO | HC | CO |
| CeO₂/CeZrRO | No. 1 | 10% by | 218 | 206 | 224 | 209 | | | | |
| ratio | | mole | | | | | | | | |
| | No. 2 | 20% by | 216 | 203 | 226 | 213 | 224 | 213 | | |
| | | mole | | | | | | | | |
| | No. 3 | 45% by | 219 | 206 | 223 | 211 | | | | |
| | | mole | | | | | | | | |
| | No. 4 | 60% by | 219 | 204 | 223 | 210 | | | | |
| | | mole | | | | | | | | |
| | No. 5 | 80% by | 225 | 211 | 228 | 214 | | | | |
| | | mole | | | | | | | | |

Each of mixed oxide CeZrRO and mixed oxide ZrNdMO is in the form of secondary particles.

Reference to Tables 12 and 13 shows that when the ZrO₂ ratio was 55% to 75% by mole, both inclusive, and the CeO₂ ratio was 20% to 45% by mole, both inclusive, the inventive examples exhibited lower light-off temperatures than the comparative examples. The reason for these results can also be deemed to be that the catalyst materials of the inventive examples had higher oxygen storage/release capacity, higher oxygen ion conductivity and higher heat resistance than those of the comparative examples.

Furthermore, each of the samples of the inventive and comparative examples (the same as used for measurements relating to FIG. 18), which were each prepared by a Zr-based mixed oxide having a ZrO₂ ratio of 55% by mole and a Ce-based mixed oxide having a CeO₂ ratio of 20% by mole and had different CeZrRO ratios, was heat aged and then measured, like the case of Tables 12 and 13, in terms of light-off temperature T50 (° C.) for conversion of HC and CO according to the above-stated light-off performance test. The filter support for each sample, the amount of catalyst material carried per L of filter and the amount of Pt carried per L of filter were the same as in the case of Tables 12 and 13.

The measurement results are shown in FIG. 19. Reference to FIG. 19 shows that the inventive examples exhibited lower light-off temperatures for both of HC and CO than the comparative examples and that when the CeZrRO ratio was 25% to 75% by mass, both inclusive, the light-off performance enhanced. More preferably, the CeZrRO ratio is 25% to 65% by mass, both inclusive.

### Embodiment 4

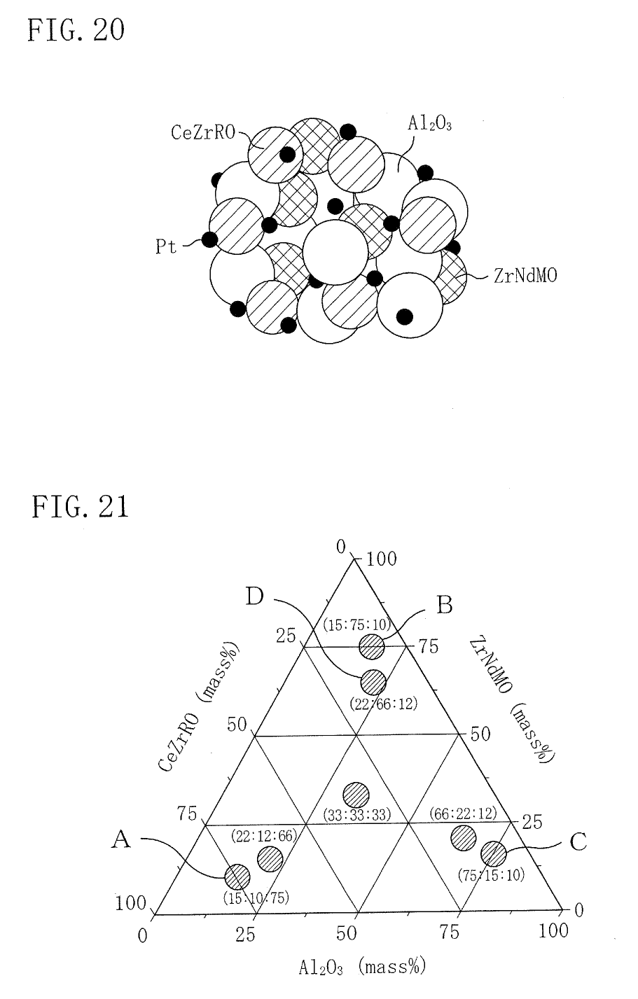

A feature of this embodiment is that the catalyst layer 7 shown in FIG. 4 contains catalyst particles (a catalyst material) as schematically shown in FIG. 20. Specifically, the catalyst particle is a secondary particle formed so that primary particles of activated alumina (particles indicated by unfilled circles; Al₂O₃), primary particles of a Zr-based mixed oxide that contains Zr and a rare earth metal Z other than Ce (cross-hatched particles; ZrNdMO), and primary particles of a Ce-based mixed oxide that contains Ce, Zr and a rare earth metal R other than Ce (hatched particles; CeZrRO) are mixed and cohere together. Pt particles (indicated by filled circles) are carried as a catalytic metal on each primary particle of activated alumina (Al₂O₃), each primary particle of the Zr-based mixed oxide (ZrNdMO) and each primary particle of the Ce-based mixed oxide (CeZrRO). The primary particles of activated alumina have a mean particle size of 1 to 100 mn, the primary particles of the Zr-based mixed oxide have a mean particle size of 5 to 50 nm and the primary particles of the Ce-based mixed oxide have a mean particle size of 5 to 100 nm.

Note that although in FIG. 20 each Zr-based mixed oxide particle is indicated as “ZrNdMO”, “ZrNdMO” is an example of Zr-based mixed oxide particle and shows a mixed oxide particle containing Zr, Nd and a rare earth metal M other than Ce and Nd. Although in this case the rare earth metal Z comprises a combination of two kinds of rare earth metals, Nd and M, the rare earth metal Z may not necessarily contain Nd.

A description is given below of the case where “ZrNdMO” is used as the Zr-based mixed oxide particle.

### <Preparation of Catalyst Material>

The catalyst material can be prepared according to the following method.

### —Preparation of Activated Alumina Particle Precursor—

A precursor of activated alumina particles can be prepared in the same manner as in Embodiment 1.

### —Preparation of Zr-Based Mixed Oxide Particle Precursor—

A precursor of the Zr-based mixed oxide particles can be prepared in the same manner as in Embodiment 1.

### —Preparation of Ce-Based Mixed Oxide Particle Precursor—

A precursor of the Ce-based mixed oxide particles can be prepared in the same manner as in Embodiment 2.

### —Mixing of Three Kinds of Particle Precursors—

The activated alumina particle precursor, the Zr-based mixed oxide particle precursor and the Ce-based mixed oxide particle precursor, which are obtained in the above steps, are mixed. Specifically, a solution containing a precipitate of the activated alumina particle precursor, a solution containing a precipitate of the Ce-based mixed oxide particle precursor and a solution containing a precipitate of the Zr-based mixed oxide particle precursor are mixed. In this case, the three solutions are previously formulated to have the same pH.

### —Other Steps for Preparation of Catalyst Material—

The other steps following the above steps, i.e., the rinsing and dehydration step, the drying and calcining step and the step of carrying a catalytic metal, are carried out in the same manner as in Embodiment 1.

Thus, a catalyst material composed of catalyst particles as shown in FIG. 20 is obtained.

### <Preferred Zr-Based Mixed Oxide Particle>

A preferred composition of the Zr-based mixed oxide particle is the same as that in Embodiment 1 (see Table 1). Therefore, it is preferable that the Zr-based mixed oxide particle contains Nd as an essential component in combination with La, Pr or Y. In the cases where the proportion of rare earth metal M oxide is low, the use of La as the rare earth metal M is advantageous in increasing the carbon burning rate. On the other hand, in the cases where the proportion of rare earth metal M oxide is high, the use of Pr as the rare earth metal M is advantageous in increasing the carbon burning rate. Furthermore, the proportion of the total amount of neodymium oxide and M oxide is preferably not less than 20% by mole in enhancing the particulate burning property. Particularly, it is preferable to attain a proportion of the above total amount of 20% by mole or more while raising the proportion of neodymium oxide or praseodymium oxide. On the other hand, the proportion of the above total amount is preferably not more than 45% by mole and more preferably not more than 40% by mole in order to restrain the amount of CO produced from increasing owing to imperfect combustion of carbon. Furthermore, it is preferable that the Zr-based mixed oxide uses Pr as the rare earth metal M and has a Pr₂O₃ ratio of 6% by mole or higher in order to increase the carbon burning rate (see FIG. 6).

### <Preferred Ce-Based Mixed Oxide Particle>

A preferred composition of the Ce-based mixed oxide particle is the same as that in Embodiment 2 (see FIG. 12). Specifically, when the Ce-based mixed oxide particles used Pr as the rare earth metal R, relatively high carbon burning rates were reached at small proportions of the rare earth metal oxide R—O of 0.3% to 2% by mole. When the Ce-based mixed oxide particles used another rare earth metal, such as Nd, La or Y, relatively high carbon burning rates were reached at proportions of the rare earth metal oxide R—O of 1% to 7% by mole or 1% to 6% by mole. Furthermore, among the four kinds of rare earth metals, the use of Nd is most advantageous in enhancing the carbon burning property and the Nd₂O₃ ratio is preferably 4% by mole.

### <ZrO₂ Ratio of Zr-Based Mixed Oxide and CeO₂ Ratio of Ce-Based Mixed Oxide>

### —Preparation of Samples—

According to the above-stated method for preparing a catalyst material, various kinds of catalyst materials of inventive examples were prepared in which primary particles of activated alumina (Al₂O₃), primary particles of Zr-based mixed oxide (ZrNdMO) and primary particles of Ce-based mixed oxide (CeZrRO) are mixed at a mass ratio Al₂O₃:ZrNdMO:CeZrRO=66:22:12 and which have different proportions of ZrO₂ in Zr-based mixed oxide primary particle (ZrO₂/ZrNdMO shown in % by mole) and different proportions of CeO₂ in Ce-based mixed oxide primary particle (CeO₂/CeZrRO shown in % by mole). Pr was used as the rare earth metal M for the Zr-based mixed oxide particle and the Pr₂O₃ ratio was fixed at 12% by mole. Nd was used as the rare earth metal R for the Ce-based mixed oxide particle and the Nd₂O₃ ratio was fixed at 4% by mole. Furthermore, the catalytic metal Pt was carried on each support material by evaporation to dryness.

Catalyst materials of comparative examples were prepared in the following manner. Specifically, activated alumina secondary particles, different kinds of Zr-based mixed oxide secondary particles having different ZrO₂ ratios and the same Pr₂O₃ ratio of 12% by mole and different kinds of Ce-based mixed oxide secondary particles having different CeO₂ ratios and the same Nd₂O₃ ratio of 4% by mole were each prepared by coprecipitation. The obtained activated alumina secondary particles, each kind of Zr-based mixed oxide secondary particles and each kind of Ce-based mixed oxide secondary particles were physically mixed at a mass ratio of 66:22:12 as in inventive examples to obtain various kinds of powdered support materials having different proportions of ZrO₂ in Zr-based mixed oxide particles and different proportions of CeO₂ in Ce-based mixed oxide particles. Then, Pt was carried on each of the powdered support materials by evaporation to dryness to obtain various kinds of catalyst materials of comparative examples.

Then, according to the previously stated method for preparing a sample, samples (catalyst-supported particulate filters) were obtained by coating the catalyst materials of the inventive examples and comparative examples on their respective SiC-made filter supports having a volume of 25 mL, a cell wall thickness of 12 mil and 300 cpsi. The amount of each catalyst material carried per L of filter was 50 g/L, and the amount of Pt carried per L of filter was 1.0 g/L. Then, each sample was heat aged by keeping it at 800° C. for 24 hours in the atmospheric environment.

### —Evaluation on Carbon Burning Property—

For each of the samples of the inventive examples and comparative examples, an amount of carbon (carbon black) corresponding to 10 g per L of filter was deposited on the walls of exhaust gas channels in the sample and the sample was then measured in terms of carbon burning rate at 590° C. according to the above-stated carbon burning property test.

The measurement results on the inventive examples and the measurement results on the comparative examples are shown in Tables 14 and 15, respectively.

TABLE 14
Inventive Example; Carbon burning rate (g/hr, 590° C.)

| | | | ZrO₂/ZrNdMO ratio | | | |
|---|---|---|---|---|---|---|
| | | | No. 1 | No. 2 | No. 3 | No. 4 |
| | | | 55% by | 75% by | 80% by | 90% by |
| | | | mole | mole | mole | mole |
| CeO₂/ | No. 1 | 10% by | 1.03 | 0.99 | 0.86 | |
| CeZrRO | | mole | | | | |
| ratio | No. 2 | 20% by | 1.15 | 1.08 | 0.91 | 0.88 |
| | | mole | | | | |
| | No. 3 | 45% by | 1.08 | 1.05 | 0.84 | 0.805 |
| | | mole | | | | |
| | No. 4 | 60% by | 0.95 | 0.91 | 0.81 | |
| | | mole | | | | |
| | No. 5 | 80% by | 0.89 | 0.88 | | |
| | | mole | | | | |

Each of mixed oxide CeZrRO and mixed oxide ZrNdMO is in the form of primary particles.

TABLE 15
Comparative Example; Carbon burning rate (g/hr, 590° C.)

| | | | ZrO₂/ZrNdMO ratio | | | |
|---|---|---|---|---|---|---|
| | | | No. 1 | No. 2 | No. 3 | No. 4 |
| | | | 55% by | 75% by | 80% by | 90% by |
| | | | mole | mole | mole | mole |
| CeO₂/ | No. 1 | 10% by | 1.05 | 1.02 | | |
| CeZrRO | | mole | | | | |
| ratio | No. 2 | 20% by | 1.08 | 1.05 | 0.92 | |
| | | mole | | | | |
| | No. 3 | 45% by | 1.06 | 0.99 | 0.91 | |
| | | mole | | | | |
| | No. 4 | 60% by | 0.96 | 0.93 | | |
| | | mole | | | | |
| | No. 5 | 80% by | 0.94 | 0.9 | | |
| | | mole | | | | |

Each of mixed oxide CeZrRO and mixed oxide ZrNdMO is in the form of secondary particles.

Reference to Tables 14 and 15 shows that when the ZrO₂ ratio was 55% to 75% by mole, both inclusive, and the CeO₂ ratio was 20% to 45% by mole, both inclusive, the inventive examples exhibited higher carbon burning rates than the comparative examples. The reason for these results can be considered to be that since in the inventive examples each kind of Zr-based mixed oxide and each kind of Ce-based mixed oxide were mixed together in the form of their primary particles of small particle size to form secondary particles each composed of a mixture of their primary particles, the oxygen ion conductivity of the Zr-based mixed oxide and the oxygen storage/release capacity of the Ce-based mixed oxide increased and the heat resistance of the catalyst material increased. Particularly, the inventive example having a ZrO₂ ratio of 55% by mole and a CeO₂ ratio of 20% by mole exhibited a good result.

### —Evaluation of Light-off Performance for Exhaust Gas Conversion—

Each of the samples of the inventive and comparative examples (the same as shown in Tables 14 and 15) was measured in terms of light-off performance for conversion of HC and CO in exhaust gas in the same manner as the light-off performance test in Embodiment 1 without deposition of carbon black.

The measurement results on the inventive examples and the measurement results on the comparative examples are shown in Tables 16 and 17, respectively.

TABLE 16
Inventive Example; Light-off temperature T50 (° C.)

| | | | ZrO₂/ZrNdMO ratio | | | | | | | |
|---|---|---|---|---|---|---|---|---|---|---|
| | | | No. 1 | | No. 2 | | No. 3 | | No. 4 | |
| | | | 55% by | | 75% by | | 80% by | | 90% by | |
| | | | mole | | mole | | mole | | mole | |
| | | | HC | CO | HC | CO | HC | CO | HC | CO |
| CeO₂/ | No. 1 | 10% by | 210 | 196 | 215 | 202 | | | | |
| CeZrRO | | mole | | | | | | | | |
| ratio | No. 2 | 20% by | 204 | 191 | 207 | 194 | 219 | 205 | 221 | 208 |
| | | mole | | | | | | | | |
| | No. 3 | 45% by | 205 | 191 | 207 | 195 | 224 | 210 | 226 | 211 |
| | | mole | | | | | | | | |
| | No. 4 | 60% by | 211 | 199 | 217 | 206 | 227 | 214 | | |
| | | mole | | | | | | | | |
| | No. 5 | 80% by | 216 | 202 | 220 | 209 | | | | |
| | | mole | | | | | | | | |

Each of mixed oxide CeZrRO and mixed oxide ZrNdMO is in the form of primary particles.

TABLE 17
Comparative Example; Light-off temperature T50 (° C.)

| | | | ZrO₂/ZrNdMO ratio | | | | | | | |
|---|---|---|---|---|---|---|---|---|---|---|
| | | | No. 1 | | No. 2 | | No. 3 | | No. 4 | |
| | | | 55% by | | 75% by | | 80% by | | 90% by | |
| | | | mole | | mole | | mole | | mole | |
| | | | HC | CO | HC | CO | HC | CO | HC | CO |
| CeO₂/CeZrRO | No. 1 | 10% by | 208 | 194 | 213 | 201 | | | | |
| ratio | | mole | | | | | | | | |
| | No. 2 | 20% by | 208 | 194 | 210 | 196 | 215 | 202 | | |
| | | mole | | | | | | | | |
| | No. 3 | 45% by | 209 | 195 | 211 | 197 | 217 | 204 | | |
| | | mole | | | | | | | | |
| | No. 4 | 60% by | 210 | 196 | 215 | 201 | | | | |
| | | mole | | | | | | | | |
| | No. 5 | 80% by | 212 | 199 | 218 | 206 | | | | |
| | | mole | | | | | | | | |

Each of mixed oxide CeZrRO and mixed oxide ZrNdMO is in the form of secondary particles.

Reference to Tables 16 and 17 shows that when the ZrO₂ ratio was 55% to 75% by mole, both inclusive, and the CeO₂ ratio was 20% to 45% by mole, both inclusive, the inventive examples exhibited lower light-off temperatures than the comparative examples. The reason for these results can also be deemed to be that the catalyst materials of the inventive examples had higher oxygen storage/release capacity, higher oxygen ion conductivity and higher heat resistance than those of the comparative examples.

### <Mixing Ratio of Activated Alumina, Zr-Based Mixed Oxide and Ce-Based Mixed Oxide>

### —Preparation of Samples—

Catalyst samples of inventive examples (mixture of primary particles) and comparative examples (mixture of secondary particles) were prepared in the above-stated manner by fixing the ZrO₂ ratio of the Zr-based mixed oxide at 55% by mole, fixing the CeO₂ ratio of the Ce-based mixed oxide of 20% by mole and changing the mixing ratio among activated alumina, the Zr-based mixed oxide and the Ce-based mixed oxide (the mass ratio Al₂O₃:ZrNdMO:CeZrRO). FIG. 21 is a triangular chart showing the mass ratios of the samples of the inventive examples among activated alumina primary particles, Zr-based mixed oxide primary particles and Ce-based mixed oxide primary particles.

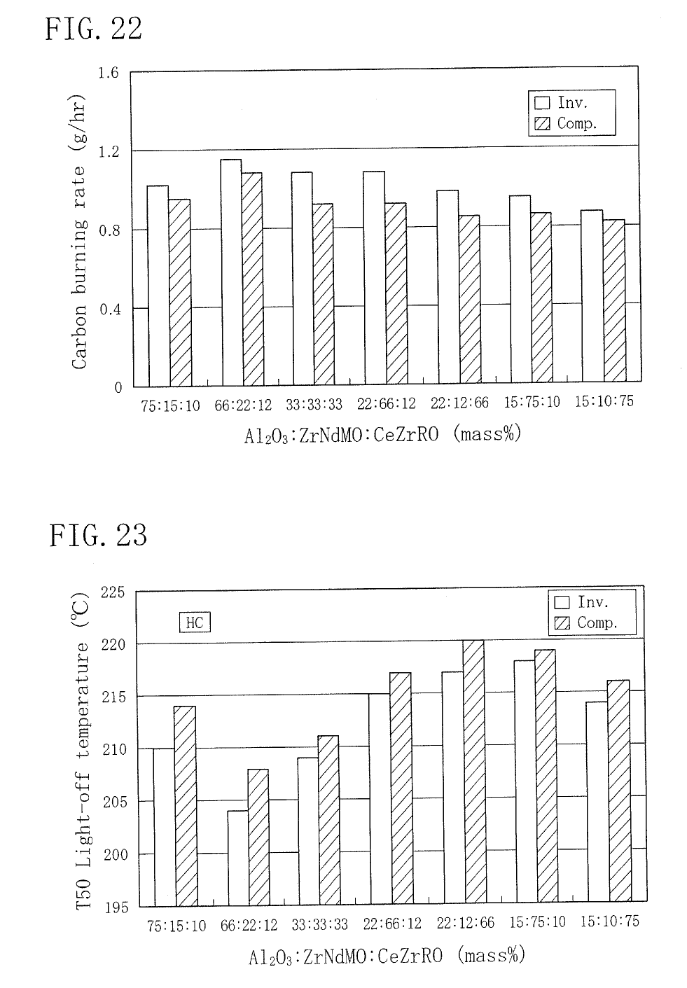

Note that in FIG. 21 the value “33” at the center point (33:33:33) of the triangular chart should be strictly shown as “33+⅓” but is here shown as “33” for convenience. This applies also to FIGS. 22 to 24 and Tables 18 and 19 all of which are described later.

### —Evaluation on Carbon Burning Property—

Then, each of the samples of the inventive examples and comparative examples was heat aged in the above-stated manner, carbon was deposited on the walls of exhaust gas channels in the sample in the above-stated manner and the sample was then measured in terms of carbon burning rate at 590° C. according to the above-stated carbon burning property test.

The filter support for each sample, the amount of catalyst material carried per L of filter and the amount of Pt carried per L of filter were the same as in the cases of Tables 14 to 17. The measurement results are shown in Table 18 and FIG. 22.

TABLE 18

| AlO:ZrNdMO:CeZrRO | Carbon burning rate (g/hr) | |
|---|---|---|
| (mass ratio) | Inventive Example | Comparative Example |
| 75:15:10 | 1.02 | 0.95 |
| 66:22:12 | 1.15 | 1.08 |
| 33:33:33 | 1.08 | 0.92 |
| 22:66:12 | 1.08 | 0.92 |
| 22:12:66 | 0.98 | 0.85 |
| 15:75:10 | 0.95 | 0.86 |
| 15:10:75 | 0.87 | 0.82 |

Reference to Table 18 and FIG. 22 shows that at all of the mixing ratios the inventive examples exhibited higher carbon burning rates than the comparative examples. Furthermore, for the inventive examples, the carbon burning rate reached the highest at a mass ratio Al₂O₃;ZrNdMO:CeZrRO of 66:22:12 and tended to drop with approach towards peripheral points of the triangular chart shown in FIG. 21, i.e., Point C where the Al₂O₃ ratio was high (75:15:10), Point B where the ZrNdMO ratio was high (15:75:10) and Point A where the CeZrRO ratio was high (15:10:75). Furthermore, the difference in carbon burning rate between each pair of inventive and comparative examples having the same mass ratio tended to reduce with approach towards peripheral points of the triangular chart.

### —Evaluation of Light-off Performance for Exhaust Gas Conversion—

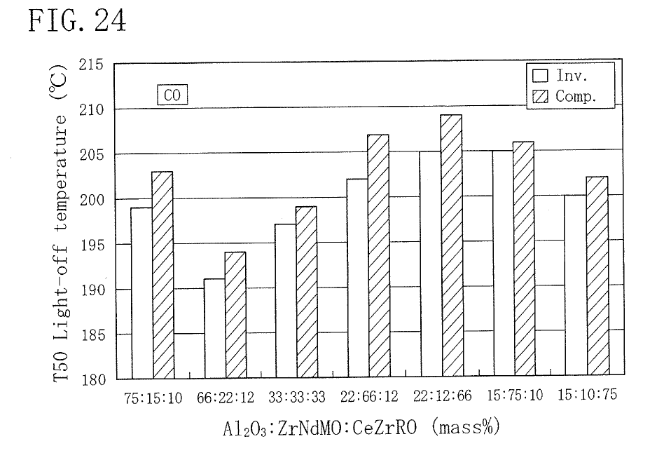

Furthermore, each of the samples of the inventive examples and comparative examples was heat aged in the above-stated manner and then measured in terms of light-off temperature for conversion of HC and CO according to the above-stated light-off performance test. The light-off temperatures for HC conversion are shown in Table 19 and FIG. 23 and the light-off temperatures for CO conversion are shown in Table 19 and FIG. 24.

TABLE 19

| | Light-off temperature T50 (° C.) | | | |
|---|---|---|---|---|
| | HC conversion | | CO conversion | |
| | | Compar- | | Compar- |
| AlO:ZrNdMO:CeZrRO | Inventive | ative | Inventive | ative |
| (mass ratio) | Example | Example | Example | Example |
| 75:15:10 | 210 | 214 | 199 | 203 |
| 66:22:12 | 204 | 208 | 191 | 194 |
| 33:33:33 | 209 | 211 | 197 | 199 |
| 22:66:12 | 215 | 217 | 202 | 207 |
| 22:12:66 | 217 | 220 | 205 | 209 |
| 15:75:10 | 218 | 219 | 205 | 206 |
| 15:10:75 | 214 | 216 | 200 | 202 |

Reference to Table 19 and FIGS. 23 and 24 shows that at all of the mixing ratios the inventive examples exhibited lower light-off temperatures than the comparative examples. Furthermore, for the inventive examples, the light-off temperature basically tended to increase with approach towards peripheral points of the triangular chart, except for Point A where the CeZrRO ratio was high (15:10:75). Furthermore, the difference in light-off temperature between each pair of inventive and comparative examples having the same mass ratio tended to reduce with approach towards peripheral points of the triangular chart.

—Summary about Mixing Ratio—

According to the present invention, it can be said from the evaluation results on carbon burning property and light-off performance as described so far that when the mass ratio among activated alumina particles, Zr-based mixed oxide particles and Ce-based mixed oxide particles is within the range enclosed by the lines connecting Point A (15:10:75), Point B (15:75:10) and Point C (75:15:10) of the triangular chart shown in FIG. 21, the particulate burning property can be enhanced while the low-temperature HC conversion performance and CO conversion performance can be enhanced.

More preferably, the mass ratio among the three kinds of particles is within the range enclosed by the lines connecting Point A (15:10:75), Point C (75:15:10) and Point D (22:66:12) of the triangular chart shown in FIG. 21.

What is claimed is:

1. A particulate filter in which a catalyst layer is formed on the walls of exhaust gas channels in a filter body for trapping particulates exhausted from an engine, the catalyst layer containing a catalyst material in the form of secondary particles, each said secondary particle being formed so that at least two kinds of primary particles selected from the group consisting of primary particles of activated alumina, primary particles of a Zr-based mixed oxide containing Zr and a rare earth metal Z other than Ce and primary particles of a Ce-based mixed oxide containing Ce, Zr and a rare earth metal R other than Ce are mixed and cohere together.

2. The particulate filter of claim 1, wherein
the catalyst material comprises secondary particles in each of which primary particles of the activated alumina and primary particles of the Zr-based mixed oxide cohere together, each said primary particle of the Zr-based mixed oxide containing, as the rare earth metal Z, Nd and a rare earth metal M other than Ce and Nd,
each of the primary particles of the Zr-based mixed oxide contains ZrO₂ at a proportion of 55% to 78% by mole, both inclusive, and
the proportion of the primary particles of the Zr-based mixed oxide in the total amount of the primary particles of the activated alumina and the primary particles of the Zr-based mixed oxide is 25% to 90% by mass, both inclusive.

3. The particulate filter of claim 2, wherein the rare earth metal M is at least one selected from the group consisting of La and Pr.

4. The particulate filter of claim 2, wherein Pt is carried as a catalytic metal on the secondary particles.

5. The particulate filter of claim 1, wherein
the catalyst material comprises secondary particles in each of which primary particles of the activated alumina and primary particles of the Ce-based mixed oxide cohere together, and
each of the primary particles of the Ce-based mixed oxide contains CeO₂ at a proportion of 20% to 60% by mole, both inclusive.

6. The particulate filter of claim 5, wherein the proportion of the primary particles of the Ce-based mixed oxide in the total amount of the primary particles of the activated alumina and the primary particles of the Ce-based mixed oxide is 10% to 75% by mass, both inclusive.

7. The particulate filter of claim 5, wherein each of the primary particles of the Ce-based mixed oxide contains CeO₂ at a proportion of 20% to 45% by mole, both inclusive.

8. The particulate filter of claim 5, wherein the rare earth metal R is at least one selected from the group consisting of Nd, La, Pr and Y.

9. The particulate filter of claim 5, wherein Pt is carried as a catalytic metal on the secondary particles.

10. The particulate filter of claim 1, wherein
the catalyst material comprises secondary particles in each of which primary particles of the Zr-based mixed oxide and primary particles of the Ce-based mixed oxide cohere together, each said primary particle of the Zr-based mixed oxide containing, as the rare earth metal Z, Nd and a rare earth metal M other than Ce and Nd,
each of the primary particles of the Zr-based mixed oxide contains ZrO₂ at a proportion of 55% to 75% by mole, both inclusive, and
each of the primary particles of the Ce-based mixed oxide contains CeO₂ at a proportion of 20% to 45% by mole, both inclusive.

11. The particulate filter of claim 10, wherein the proportion of the primary particles of the Ce-based mixed oxide in the total amount of the primary particles of the Zr-based mixed oxide and the primary particles of the Ce-based mixed oxide is 25% to 75% by mass, both inclusive.

12. The particulate filter of claim 10, wherein Pt is carried as a catalytic metal on the secondary particles.

13. The particulate filter of claim 1, wherein
the catalyst material comprises secondary particles in each of which primary particles of the activated alumina, primary particles of the Zr-based mixed oxide and primary particles of the Ce-based mixed oxide cohere together, and
the mass ratio among the primary particles of the activated alumina, the primary particles of the Zr-based mixed oxide and the primary particles of the Ce-based mixed oxide is within the range enclosed by the lines connecting Point A (15:10:75), Point B (15:75:10) and Point C (75:15:10) in a triangular chart formed by the primary particles of the activated alumina, the primary particles of the Zr-based mixed oxide and the primary particles of the Ce-based mixed oxide.

14. The particulate filter of claim 13, wherein each of the primary particles of the Ce-based mixed oxide contains, as the rare earth metal R, at least one selected from the group consisting of Nd, La and Pr and contains CeO₂ at a proportion of 20% to 45% by mole, both inclusive.

15. The particulate filter of claim 13, wherein each of the primary particles of the Zr-based mixed oxide contains ZrO₂ at a proportion of 55% to 75% by mole, both inclusive.

16. The particulate filter of claim 13, wherein Pt is carried as a catalytic metal on the secondary particles.
